(19) United States
(12) Patent Application Publication
(10) Pub. No.: US 2009/0259493 A1
(43) Pub. Date: Oct. 15, 2009

(54) MOBILE HEALTH BOOK

(76) Inventors: Medhi O. Venon, Whitefish Bay, WI (US); Jie Xue, Whitefish Bay, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/421,729

(22) Filed: Apr. 10, 2009

Related U.S. Application Data
(60) Provisional application No. 61/044,265, filed on Apr. 11, 2008.

(51) Int. Cl. G06Q 50/00; H04B 1/38; G06Q 10/00

(52) U.S. Cl. 705/3; 455/90.1

(57) ABSTRACT

A mobile health book (MHB) is incorporated into a mobile device such that users can manage and track health care related information for the user. The mobile health book includes a health tracking software program stored on the memory of the mobile device. The health tracking software receives and stores various health related information for the user. The health tracking software program communicates with at least the contact management program and calendar program on the mobile device to integrate the function of these programs with the health tracking software. The mobile device is able to communicate with other mobile devices such that health related information from the mobile device can be shared and synchronized with similar information on a second mobile device. The synchronization and sharing of health related information between multiple mobile devices allows the user of one mobile device to track and monitor health related information for a second user through the wireless sharing of information.

### CROSS-REFERENCE TO RELATED APPLICATION

The present application is based on and claims priority to U.S. Provisional Patent Application Ser. No. 61/044,265 filed on Apr. 11, 2008.

### BACKGROUND OF THE INVENTION

Consumers (users) presently pay increasing attention to managing the health and wellbeing of themselves and their loved ones. With the advancement of medical science, technology and service, coupled with general complexity in navigating the overall health system, the amount and complexity of information and tasks relating to the consumer health is exponentially increasing.

IT solutions to help consumers managing personal health are emerging in recent years. For example, there are online services and computer based applications to help consumers manage their Personal Health Records (PHR). But such solutions are only beginning to make inroads in user adoption. According to an ongoing online opinion poll conducted by myPHR.com on how people maintain their personal health information,
43% people do not maintain personal health information at all
40% use loose leaf binder or paper file
14% maintain on their computer
2% through an online service.

It is believed that the slower-than-expected adoption of current computer/online PHR solutions may be due to the habit/convenience and intuitiveness factors. Many people today do not track their financial wealth well enough and track their personal/family health even worse. The requirement of having to use a computer or go online to track or access a health record, usually after the fact, is not a habit for most people, because it needs to be done as a separate task that is simply inconvenient.

A mobile phone is often the most hi-tech portable device a person will carry with him at all times. This is particularly true in some rural areas in the world, where people don't even have regular phone lines, computers or Internet access. With the technology advancements and product convergence, mobile internet devices have been rapidly gaining versatility. Many phones or portable devices are no longer just a device for people to make phone calls, but also include email, Internet access, contact address book, calendar, task, camera functionalities, to name a few. It indeed is now a powerful hi-tech mobile device that is every consumer's ‘electronic assistant’ of communication and information/task management.

Realizing the power of these mobile devices, the OEMs of these mobile devices are opening up their development platforms to allow the general public to develop applications on the mobile devices, such as, Palm's opening of its Palm OS and Windows platforms for Treo mobile phone, Google's release of Android open platform in November 2007, and Apple's opening of its iPhone platform in March 2008. These are just several of the mobile devices currently available to the public. It is anticipated that many other mobile devices will become available in the near future with a vast number of applications and programs.

According to this disclosure, it is believed that a mobile device-based software application is the most convenient solution for the consumers to manage, share, track and exchange the information, tasks, and records of their personal health.

For the purpose of clarity, in the present disclosure, a mobile device is meant to refer to any hand-held device that has both wireless phone/network capability and the capability to run/support software applications. At the time of this disclosure, iPhone or iPod Touch by Apple, phone(s) released or to be released with Google Android operating system, Blackberry by RIM, and Treo by Palm with Palm OS or Windows Mobile operating systems, are some examples of a mobile device. However, this list is only meant for illustrative purposes and is not meant to limit the scope of the term mobile device.

### SUMMARY OF THE INVENTION

The present disclosure generally relates to a health tracking system that allows a user to monitor not only their health related information but the health related information of other individuals. More specifically, the present disclosure relates to a health tracking software program that resides in the memory of a mobile device that has cellular phone capability and/or wireless networking capability such that the mobile device can be used by the user to monitor their own health related information and health related information of others and the ability to store the data on the cellular phone and/or to exchange the data with online storage server

The health tracking system typically operates on a mobile device that has cellular phone capability and/or wireless networking capability within the mobile device. Preferably, the mobile device includes memory, a contact management program stored within the mobile device, and address book and a calendar program that is also stored within the mobile device. The mobile device may include other optional and additional functions/features such as but not limited to an internet connection, fax capability, email capability, instant messaging and many other applications that are currently utilized in commercially available mobile devices.

The health tracking software program is stored on the memory of the mobile device where the health tracking software program includes multiple modules that allow the health tracking software program to receive health related information for at least the user and store the health related information within the memory of the mobile device. The health tracking software program will be referred to as a mobile health book (MHB). However, the health tracking software program could have various different forms and formats while operating within the scope of the present disclosure.

The MHB stored on the mobile device allows the user to record and store information related to at least the care providers for the user, a visit scheduled for the user, medication taken by the user, a listing of pharmacies or related facilities such as but not limited to imaging centers, labs, hospitals, treatment centers, including complete contact information for these facilities, a log of past measurements or test results taken for the user or any registered individuals, and possibly a complete health history for the specific user or registered individuals. The information stored within the various modules of the MHB can be imported into the MHB from a variety of sources, such as an offsite, remote personal health record (PHR) for the user. Additionally, since the mobile device has communication capability, the mobile device can obtain various types of information for the modules described above, either directly from a medical device or from healthcare IT systems. The MHB can retrieve this information either directly from the devices/databases or through an MHB server utilizing a conventional internet interface.

In addition to storing, displaying and monitoring health related information for the user of the mobile device, the health tracking system of the present disclosure allows the mobile device to store, display and monitor health related information from another member. In this manner, a single mobile device owned by a single user can be used to monitor and store health related information from a plurality of members. As an example, a person can utilize a single mobile device to store and monitor health related information from children, spouses, parents and/or pets.

Since the mobile device has communication capability, it is contemplated that a first mobile device can communicate with a second mobile device to share and synchronize health related information between the two mobile devices. The sharing of information is limited by authentication between the two devices to ensure that the health related information is not improperly shared among unauthorized recipients.

In one embodiment of the MHB, the MHB can generate a display on the mobile device that correlates measurement or test results data for the user on a visual display having a range of normal values for the measurement. Through the display, the user can determine whether a measurement or test results value is within an acceptable range. Alternatively, the display can be utilized by the user to actually enter the measurement or test results data through a touch screen or keyboard on the mobile device.

Various other features, objects and advantages of the invention will be made apparent from the following description taken together with the drawings.

### BRIEF DESCRIPTION OF THE DRAWINGS

The drawings illustrate the best mode presently contemplated of carrying out the invention. In the drawings:

FIG. 1 is a schematic illustration showing the connectivity between a mobile device including the mobile health book and various other healthcare IT systems and medical devices;

FIG. 2 is a schematic illustration of the communication between mobile health book and other applications on the same mobile device. FIG. 2 also illustrates the communication between mobile health book and mobile health book server, and personal health record that may reside elsewhere (online or on computer) that allows information from the mobile device to be exchange and analyzed;

FIG. 3 is a schematic illustration of the interaction between the standard mobile health book on the mobile device and various add-ons that can be tailored to specific health related applications for the member;

FIG. 4 is a schematic illustration of the major components and basic features of the mobile health book;

FIG. 5 is an illustration of the components within the mobile health book that relate to contact information for the members and health related contacts, and contact related features;

FIG. 6 is a schematic illustration of the relationships between the major components of the mobile health book;

FIG. 7 is a schematic illustration of the communication and related features between the member component and various other components within the mobile health book;

FIG. 8 is a schematic illustration of the communication and related features between the care provider component and various other components within the mobile health book;

FIG. 9 illustrates the communication and related features between the visit component and various other components within the mobile health book;

FIG. 10 is an illustration of the communication and related features between the medication component and various other components within mobile health book;

FIG. 11 is an illustration of the communication and related features between the pharmacy component and the medication component;

FIG. 12 is an illustration of the communication and related features between the measurement or test results component and various other components within the mobile health book;

FIG. 13 is an illustration of the communication and related features between the log component and various other components within the mobile health book;

FIG. 14 is an illustration of the communication and related features between the health history components and various other components within the mobile health book;

FIG. 15 is a schematic illustration of the communication between a mobile device including the mobile health book and a computer for the individual user;

FIG. 16 is a further illustration showing the different types of communication possible directly between two separate mobile devices including mobile health book;

FIG. 17 is a schematic illustration of the communication between mobile devices including mobile health book that's facilitated through a mobile health book server;

FIG. 18 is an illustration of how a user may use mobile health book from his/her mobile device, to manage the various aspects relating to the health of multiple members, such as, visits to care providers (doctors, surgeons, nurses, veterinarian, veterinarian surgeon, or any type of caregivers), medications & pharmacies, measurements (vital signs) or test results tracking, health logs (diary) recording and other important health history information, etc.;

FIG. 19 illustrates a set of sample screen displays relating to the member component on a mobile device including the MHB;

FIGS. 20A-C illustrate a set of sample screen displays relating to the care provider component on a mobile device including the MHB;

FIGS. 21A-C illustrate a set of sample screen displays relating to the visit component (i.e., a visit to a care provider) on a mobile device including the MHB;

FIGS. 22A-B illustrate a set of sample screen displays relating to the medication component on a mobile device including the MHB;

FIG. 23 illustrates a sample screen display of a ‘numeric entry pad’ on a mobile device including the MHB;

FIGS. 24A-B illustrate a set of sample screen displays relating to the measurement component on a mobile device including the MHB;

FIG. 25A-B illustrate a set of sample screen displays relating to the log component on a mobile device including the MHB;

FIG. 26A-C illustrate a set of sample screen displays for the mobile health book's main page on a mobile device including the MHB;

FIG. 27 illustrates a screen display for a member's main page on a mobile device including the MHB;

FIGS. 28A-B illustrate a set of sample screen displays for the list of care providers on a mobile device including the MHB; and

FIG. 29 is an illustration of the measurement display screen that can be used to enter measurements and display normal ranges of measurements relative to the recorded measurement for the user/member.

### DETAILED DESCRIPTION OF THE INVENTION

Throughout this disclosure, the term Mobile Health Book (‘MHB’) refers to a health tracking software program that brings healthcare related information and task management/tracking and sharing/exchange to the user's fingertips, i.e., the mobile devices they always carry on hand, so they may capture, access, track, and share/exchange the information on the spot right away. MHB may be used for a number of individuals (members) or pets that user(s) care for.

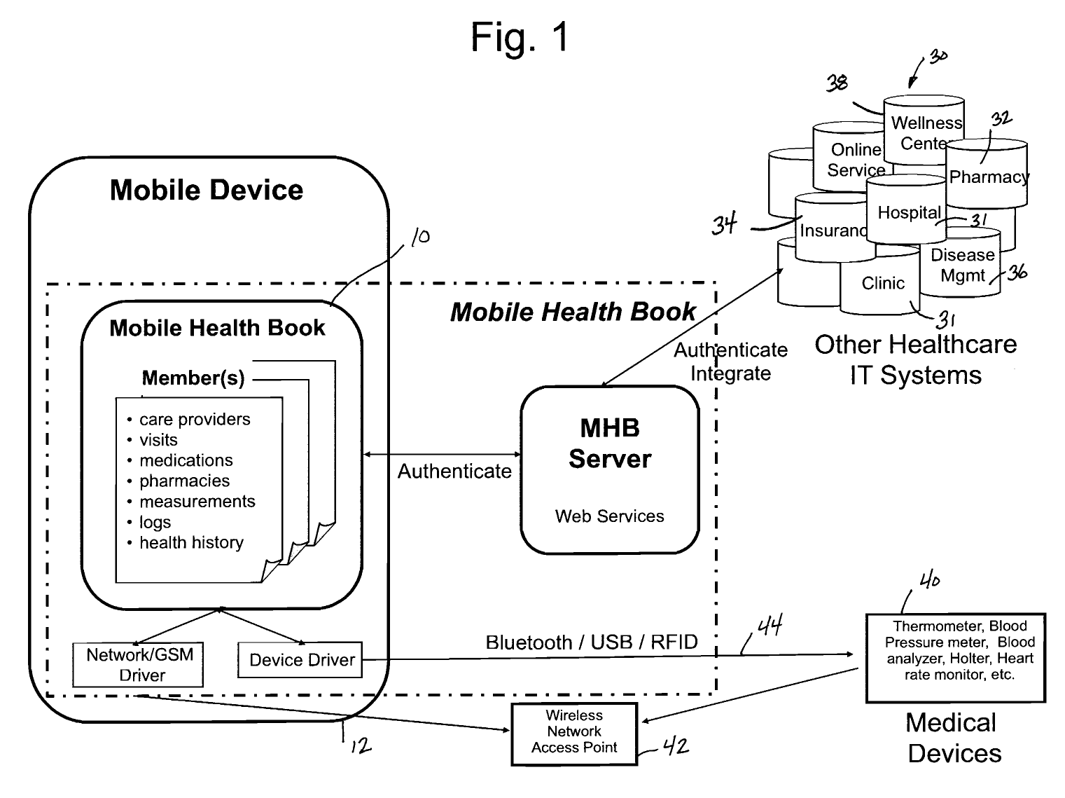

The capabilities of MHB have multiple facets. As shown in FIG. 1, the core of MHB 10 is to organize each member's health related information in an easy-to-follow way, such as, but not limited to:
Doctor/care provider visits
Care provider events such as but not limited to home care, recurrent care
Medications & pharmacies
Vital sign/measurement or test results tracking (e.g., temperature, height/weight, blood tests, cholesterol tests, etc.)
Health log/diary recording (e.g., newborn feeding/changing/sleeping record, blood pressure monitoring, chronic respiratory insufficiency, etc.)
Important medical history information (e.g., major illness, allergy, immunization, etc.).
Import medical treatment or surgery events

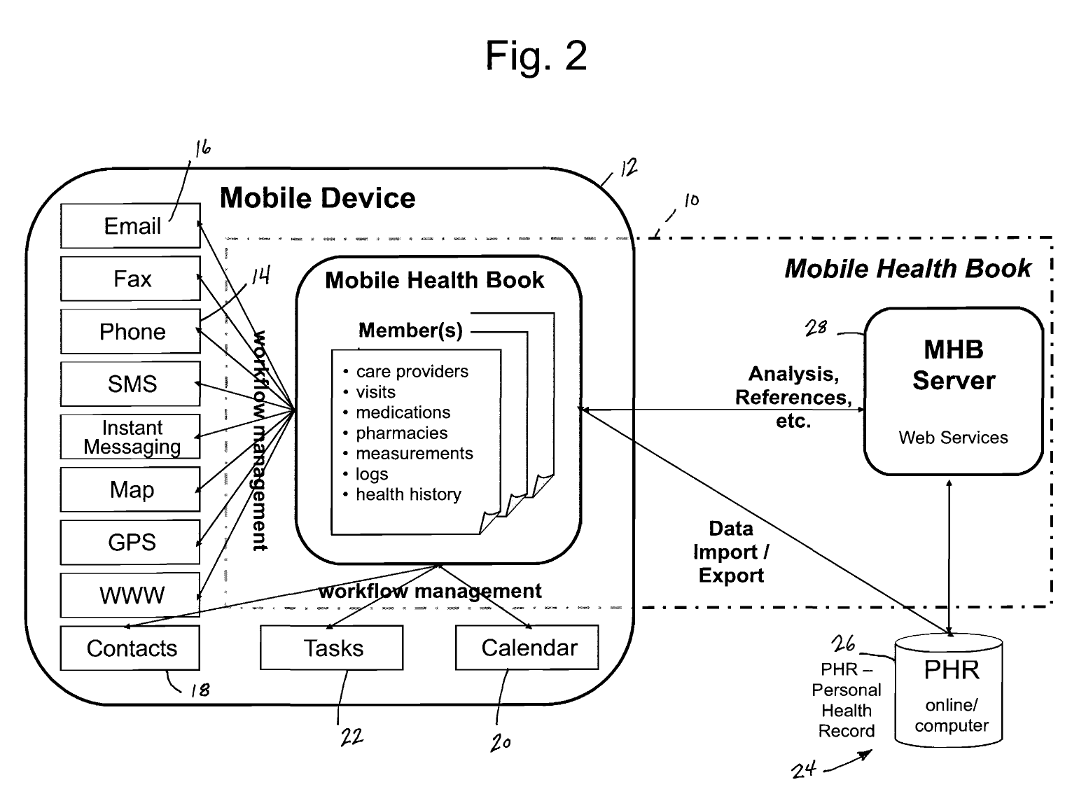

As shown in FIG. 2, the MHB is stored in memory of a mobile device 12 and leverages a mobile device's 12 existing phone 14, email 16, contact management and address book 18, calendar 20 and task applications 22 so a user may conveniently manage related tasks and workflow directly on the mobile device 12, for example, but not limited to:
Call/Map/Search a care provider, a pharmacy, a member, etc.
Send health related information to a care provider, a pharmacy, etc. by Email/Fax/Instant Messaging
Send prescriptions (Rx) to pharmacy
Schedule a doctor visit as a calendar item
Set up ‘fill/refill medication’, ‘take medication’ or ‘record next log’ reminders.
Set up recurring monitoring or caring events, such as, but not limited to taking medications, monitoring a chronic health condition (e.g., diabetes, asthma, etc. . . . )

As shown in FIG. 2, as a user uses MHB 10 to manage health information, tasks and workflow, MHB 10 naturally builds/adds into the member's Personal Health Records (PHR) 24, shown stored at a remote database 26. Such adds may be, but are not limited to:
Doctor visit history
Medication history
Care provider contact listing.
Measurement/Test Results,
Other health related information, such as but not limited to radiology images, radiology reports, treatment plans/reports/summaries, etc.

Also shown in FIG. 2, with the health-related information captured over time into MHB 10, users may leverage the advanced analysis and reference capabilities of a MHB Server 28, through a MHB Web Portal, to manage other aspects of healthcare, such as, but not limited to:
Healthcare spending tracking to help users track out-of-pocket spending, insurance deductible, FSA (flexible spending account), HSA (Health Saving Account), etc.
Comprehensive view of a member's medication history, by medication categories, etc.; with links to drug information and/or drug price comparison sites for research/reference.

For the purpose of the present disclosure, the MHB is not specifically designed to address Diet, Fitness or Weight management, but may easily allow users to do so.

Healthcare management is never an individual act. It is true from a professional/clinical standpoint; it is also true from a consumer/patient standpoint. In reality, family members jointly manage family health/wellbeing; families also hire and manage professional helpers. The MHB is built on this premise.

Through easy information sharing and exchange, MHB allows multiple users to jointly participate in managing members' health in a variety of different ways, such as, but not limited to:
A couple jointly manage the health of their kids', themselves and their pets'
Parents who live separately but jointly manage the health of their kid(s)
Adult siblings assisting the management of the health of their elderly parent(s) or disabled/impaired sibling(s) remotely, with daily information sent from/to multiple home care caregivers.

The MHB 10 of the present disclosure helps consumers easily manage their healthcare in a connected way. As shown in FIG. 2, the mobile device 12 based MHB 10 feeds/retrieves information into/from online/computer based Personal Health Record (PHR) applications.

In accordance with the present disclosure and as shown in FIG. 1, the MHB provides open connectivity interfaces, which makes it easy to connect to a variety of different other healthcare IT systems 30 to further automate consumer health workflow management, and for the consumers to access to more sophisticated health analysis systems. Subject to regulations and IT integration with other vendors/providers, such examples may include, but not limited to:
Integrate with hospital/clinic IT systems 31 to schedule appointments, place order to retrieve partial/complete personal Electronic Medical Records (EMR), Electronic Health Record (EHR), etc.
Integrate with pharmacy IT systems 32 to order medication
Integrate with insurer's IT systems 34 to get procedure authorization
Integrate with disease management provider's IT systems 36 to report daily activities
Integrate with online wellness/exercise plan services 38.

Also shown in FIG. 1, the MHB's connectivity may also extend to consumer health devices (blood sugar monitoring, thermometer, blood pressure, scale, etc.) or medical devices 40, which acquire vital signs or perform procedures, so such vital sign/measurement or in vitro signs tracking and log recordings may be captured automatically. The term medical devices should be understood to encompass all types of medical devices or medical instruments that can obtain information from a patient. The medical devices and/or instruments communicate information from the device/instrument to the MHB. In the embodiment shown, the communication to the medical devices 40 is through a wireless access point 42. Alternatively, the mobile device 12 could communicate directly to the medical devices 40 using a wired connection 43 or a wireless protocol 44, such as Bluetooth, UIB or RFID. Subject to regulations and IT integration with other vendors/providers, such examples may include, but not limited to:
Integration with weight scales, etc.
Integration with glucose meters, holters, etc.
Integration with home ventilators, home dialysis equipment, CPAP device, etc.

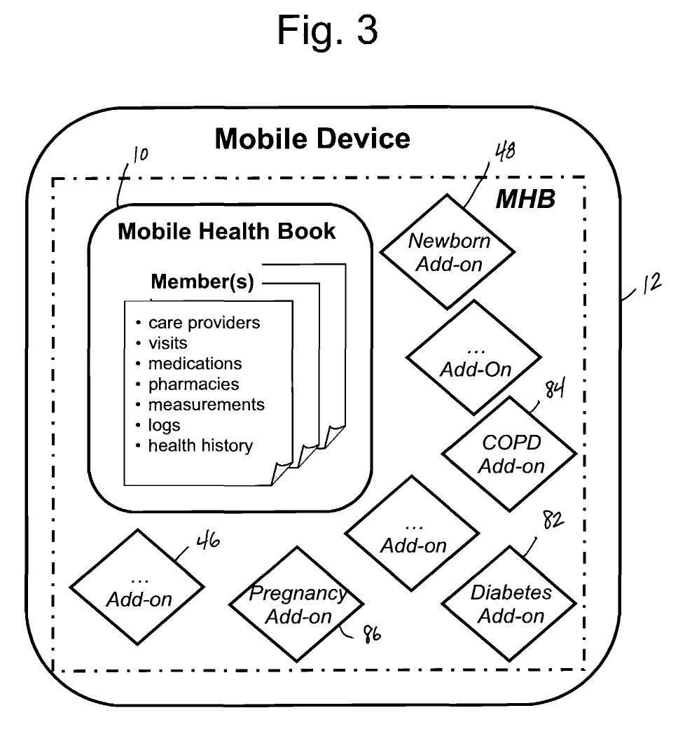

The MHB 10 further simplifies the workflow & user interface of health management by providing Member Profile/Behavior/Preference Based optional add-on's, as shown in FIG. 3. The optional add-on's 46 are directed to applications that include certain information, events or tasks that are commonly the focus for certain types of members are front-and-center in this member's user interface, coupled with the easiest workflow features. Such type of ‘personalized’ user interface and workflow may change as the member's situation changes, without risking losing any information.

For example, a newborn's add-on 48 main page may include, but not necessarily or limited to the following direct links:
Feeding records
Sleeping records
Changing records
Wellness visits
Immunization records
childcare daily logs
recurrent therapist session log

These links may be safely removed once the newborn grows older, with the data safely archived but still easily retrievable.

The MHB empowers the user to be in the driver seat when it comes to management of the healthcare of themselves, their pets and their loved ones. One of the benefits of MHB is convenience, intuitiveness and easy of use. MHB 10 brings far greater convenience to today's consumers in managing their health and wellbeing as well as their loved ones' and pets, for at least the following reasons:
Accessibility/Availability . . . MHB leverages the most readily available intelligent device that most consumers carry on hand, i.e., a mobile device.
Consumer Centric Health Management . . . MHB manages health related tasks, information and overall ‘workflow’ completely from a consumer's viewpoint, in a personalized, integrated and connected way.
Health Management in Family Style . . . MHB manages the health of a group of members, and allows members of a group to collaborate and jointly manage through information sharing and exchange, supported by sophisticated security, authentication and authorization management.
Functionality . . . MHB well leverages the cutting-edge functionalities of today's mobile devices to allow easy communication (e.g., call, SMS, email, etc.), easy logging of the information (e.g., auto-prompt, etc.), easy information retrieval (e.g., web link, map, search, etc.) and easy information sharing & exchange, to name a few.

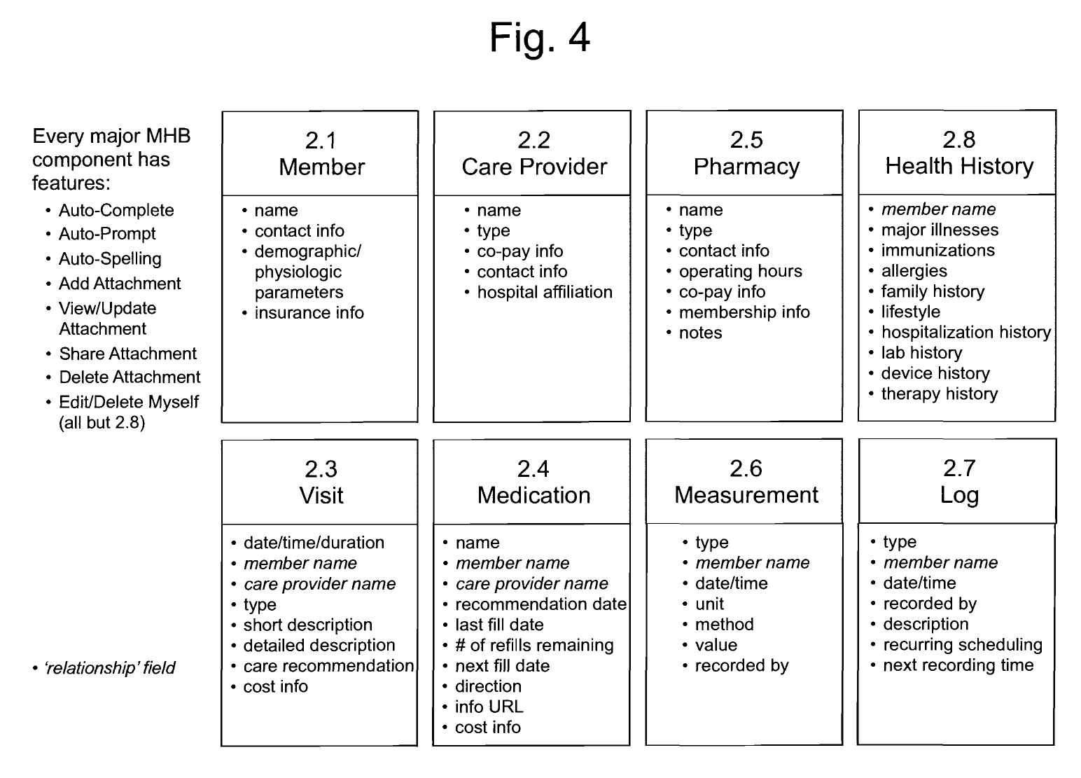

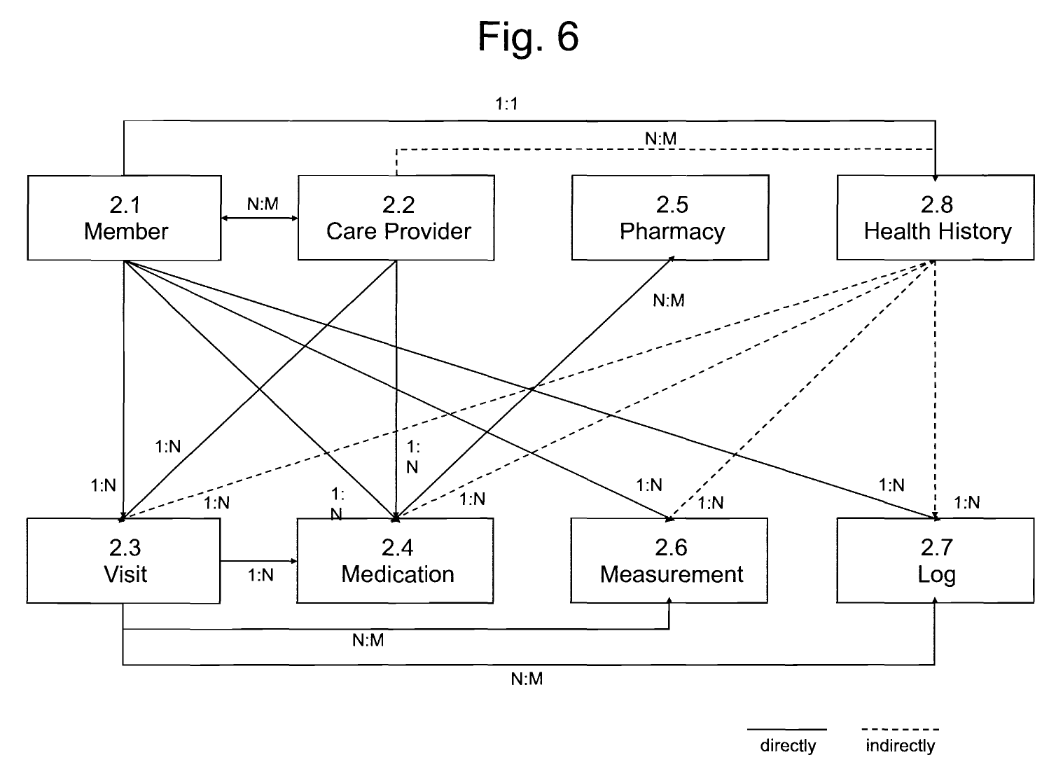

FIG. 4 provides a listing and brief description of each major component in the health tracking software program, or MHB, and the relationships (FIG. 6) and functionalities related to each component.

Throughout the following disclosure, information is entered into the mobile device using any one of a number of contemplated methods, such as an input interface on the mobile device, which may be a keypad or touch screen, a wireless or wired connection to another mobile device or medical device, or communication with a remote database. Additionally, it is contemplated that since many mobile devices are programmed to respond to voice commands or prompts, the MHB could also utilize voice prompts to enter information/commands into the MHB. The voice commands could be utilized in each of the blocks to be described below as another method of entering information.

The member block 2.1 of the MHB provides information relating to the user of the mobile device including the MHB. This member information includes, but is not limited to:
Member name or nickname
Contact information
Important demographic or physiologic parameters
Insurance information. The member block 2.1 of the MHB provides information relating to the user of the mobile devices including the MHB. This member information includes, but is not limited to:
Associated care providers

The information of MHB is centered on each individual of interest, i.e., a member. A member is identified by his/her name or nickname, in any format of user preference, such as, but not limited to, (first last) or (last, first).

Contact information related fields of a member include, but are not limited to, home phone number, cell phone number, work phone number, fax number, home address, work address, email address 1, email address 2, email address 3, etc.

During use, if a user/member is deleted from the MHB, the contact address book reference will not be deleted. If the persons name is entered into the MHB later, the information will be retrieved and the MHB will inquire as to whether the person should be made active.

Important demographic or physiologic parameters related fields of a member include, but are limited to, gender, birth date, height and weight, etc.

Insurance information related fields of a member include, but are not limited to, insurance type (medical, dental, mental, drug, vision, etc.), insurance company name, group ID, member ID, etc. An insurance record is identified in MHB's repository by the combination of insurance type, insurance company name, group ID and member ID.

When a user enters a new member, as the user types the name, MHB will prompt any existing member in its repository that matches the typed entries. If a prompted existing member is selected by the user, MHB will populate all other fields with the data retrieved from its repository, and user's new entries would become an update to the existing member, instead of adding a new one.

During use, when a new member is added to the MHB and the member's contact information does not exist in the contact repository managed by the contact management program of the mobile device, the MHB will request the contact management program to add a new entry into the repository.

When a user enters Insurance information of a new member, as the user types the insurance company name, MHB will automatically prompt any existing Insurance Record in its repository that matches the typed entries. If a prompted existing insurance record is selected by the user, MHB will populate all other Insurance Information fields with the data retrieved from its repository. If the user makes change(s) that may create a new Insurance Record (as identified by the combination of insurance type, insurance company name, group ID and member ID), MHB will keep track of the new record in its repository for future reference.

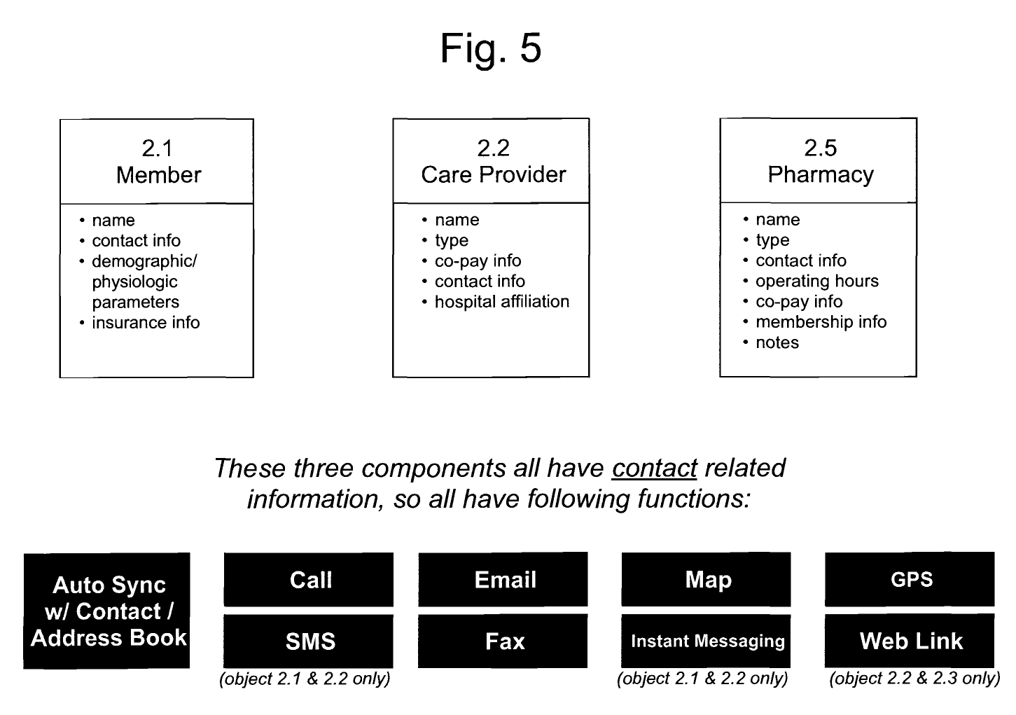

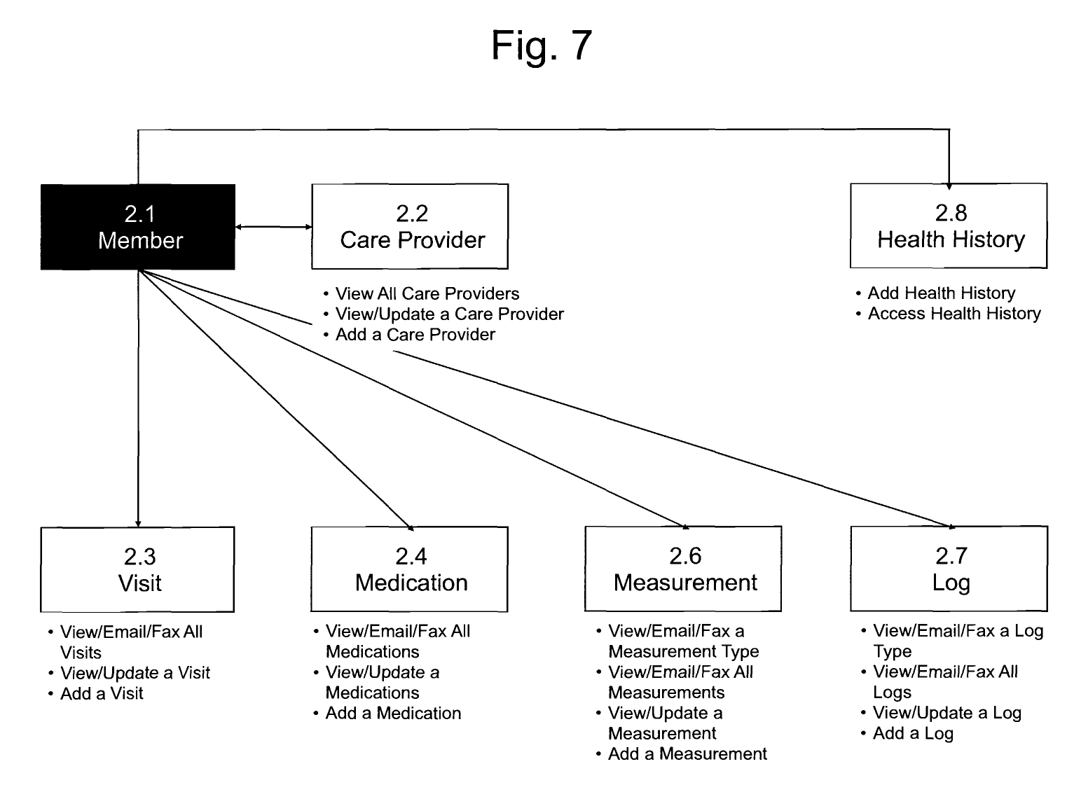

Referring now to FIGS. 5 and 7, the member function block 2.1 of the MHB allows for the following functions and communication.

Automatic Contact Synchronization function . . . MHB will automatically synchronize the member information with the mobile device's Contact or Address Book applications so update(s) either to the member information in MHB or directly to a contact in the mobile device are reflected on both real-time.

Call/SMS function . . . without leaving a member's page, a user may choose the option (either a button or a drop-down menu item) to call/SMS this member or the this member's care provider, using any of this member's or the care provider's phone numbers, and return to the same member's page after the Call/SMS to remind about health monitoring, health visits or health information. In case of care provider, the function can select between the known phone numbers to define priority of which number to call. For example, during off hours, the function can call the emergency directly and during office hours, call the work phone.

Email/Fax/Instant Messaging function . . . without leaving a member's page, a user may choose the option (either a button or a drop-down menu item) to email/fax this member or this member's care provider using any of this member's or the care provider's email addresses or fax number, and return to the same member's page after the Email/Fax/Instant Messaging.

Map/GPS function . . . without leaving a member's page, a user may choose the option (either a button or a drop-down menu item) to map this member's or this member's care provider's address using any of this member's or the care provider's addresses, and return to the same member's page after the Map/GPS.

View All Care Providers function . . . on a member's page, a user may choose the option (either a button or a menu item) to list all care providers, associated to one or multiple member(s) in MHB. A user may then choose any particular care provider to continue to View/Update a Care Provider.

View/Update a Care Provider function . . . a user may review the information of a previously entered care provider, and make changes on the individual care provider page.

Add a Care Provider function . . . on a member's page, a user may choose the option (either a button or a menu item) to add a new care provider that's associated with this particular member. MHB will bring the user to a new care provider page. A user may also indicate one out of all care providers as this member's primary physician.

View/Email/Fax All Visits function . . . on a member's page, a user may choose the option (either a button or a menu item) to list all visits associated to this particular member, which may be, but not limited to, historical or upcoming visits, from one or multiple care providers, and within a user specified time period. A user may choose any particular visit to continue to View/Update a Visit. A user may also choose the option (either a button or a menu item) to email/fax all visit details to user specific email/fax recipient(s).

View/Update a Visit/Events function . . . a user may review the information of a previously entered visit that is associated with this particular member, and make changes on the individual visit page.

Add Visit/Events function . . . on a member's page, a user may choose the option (either a button or a menu item) to add a new visit that's associated with this particular member. MHB will bring the user to the screen to add a new visit that is pre-populated with the member's information.

View/Email/Fax All Medications or Prescriptions (Rx) function . . . on a member's page, a user may choose the option (either a button or a menu item) to list all medications/Rx associated to this particular member, which may be, but not limited to, current and past medications/Rx, recommended by one or multiple care providers, prescription or over-the-counter, and within a user specified time period. A user may choose any particular medication to continue to View/Update a Medication. A user may also choose the option (either a button or a menu item) to email/fax all medication details to user specific email/fax recipient(s).

View/Update a Medication/Rx function . . . a user may review the information of a previously entered medication that is associated with this particular member, and make changes on the individual medication page.

Add a Medication/Rx function . . . on a member's page, a user may choose the option (either a button or a menu item) to add a new medication/Rx that's associated with this particular member. MHB will bring the user to the screen to add a new medication that is pre-populated with the member's information.

View/Email/Fax a Measurement, test results or test report Type function . . . on a member's page, a user may choose the option (either a button or a menu item) to view a certain type of measurement, test results associated to this particular member. MHB will group all measurements by measurement types, and list all available measurement types. A user may choose any particular measurement type to review all previously entered measurements of the same measurement type, and choose any particular measurement to continue to View/Update a Measurement. A user may also choose the option (either a button or a menu item) to email/fax all measurement details of the same measurement type to user specific email/fax recipient(s).

View/Email/Fax All Measurements, test results function . . . on a member's page, a user may choose the option (either a button or a menu item) to list all measurements associated to this particular member, during a user specified time period (such as, today). A user may choose any particular measurement to continue to View/Update a Measurement. A user may also choose the option (either a button or a menu item) to email/fax all measurement details of the specified time period to user specific email/fax recipient(s).

View/Update a Measurement function . . . a user may review the information of a previously entered measurement of this particular member, and make changes on the individual measurement page.

Add a Measurement/test results function . . . on a member's page, a user may choose the option (either a button or a menu item) to add a new measurement/test results that are associated with this particular member. MHB will bring the user to the screen to add a new measurement/test result that is pre-populated with the member's information.

View/Email/Fax a Log Type function . . . on a member's page, a user may choose the option (either a button or a menu item) to view certain type of logs associated to this particular member. MHB will group all logs by log types, and list all available log types. A user may choose any particular log type to review all previously entered logs of the same log type, and choose any particular log to continue to View/Update a Log. A user may also choose the option (either a button or a menu item) to email/fax all log details of the same log type to user specific email/fax recipient(s).

View/Email/Fax All Logs function . . . on a member's page, a user may choose the option (either a button or a menu item) to list all logs associated to this particular member, during a user specified time period (such as, today). A user may choose any particular log to continue to View/Update a Log. A user may also choose the option (either a button or a menu item) to email/fax all log details of the specified time period to user specific email/fax recipient(s).

View/Update a Log function . . . a user may review the information of a previously entered log of this particular member, and make changes on the individual log page.

Add a Log function . . . on a member's page, a user may choose the option (either a button or a menu item) to add a new log that's associated with this particular member. MHB will bring the user to the screen to add a new log that is pre-populated with the member's information.

Add Health History function . . . on a member's page, a user may choose the option (either a button or a menu item) to add the health history section for this particular member.

Access Health History function . . . on a member's page, a user may choose the option (either a button or a menu item) to access to this member's health history section.

Auto-Complete function . . . as a user types in any individual entry field, MHB will automatically complete the user entry based on previously entered value(s) that match the typed entries.\ or data from a reference database.

Auto-Prompt function . . . when applicable, MHB will automatically prompt any individual entry field with value that most logically matches the already known information.

Auto-Spelling function . . . as a user types in any individual entry field, MHB will automatically check the spelling and propose correct spelling when needed.

Add Attachment function . . . on a member's page, a user may choose the option (either a button or a menu item) to add an attachment file, which may be, but not limited to, text file, binary file, image file, video file, sound file, etc., that will be associated to this particular member. User may also include a text description of the attachment.

View/Listen/Update Attachment function . . . on a member's page, a user may choose the option (either a button or a menu item) to view/listen/update any one of the attachment files that are associated to this particular member. User may also view/update the text description of the attachment.

Share Attachment function . . . on a member's page, a user may choose the option (either a button or a menu item) to send any one or multiple attachment file(s) that are associated to this particular member to any email recipient(s).

Delete Attachment function . . . on a member's page, a user may choose the option (either a button or a menu item) to delete any one of the attachment files that are associated to this particular member.

Edit/Delete Myself function . . . on a member's page, a user may choose the option (either a button or a menu item) to edit this particular member's information, or delete this particular member from MHB.

The care provider block 2.2 of the MHB, as shown in FIG. 4, provides information relating to the care providers for the member and related participants of the member/owner of the mobile devices including the MHB. This care provider information includes, but is not limited to:
Care Provider name
Care Provider type
Co-pay information
Contact information.
Specialty
Hospital Affiliation

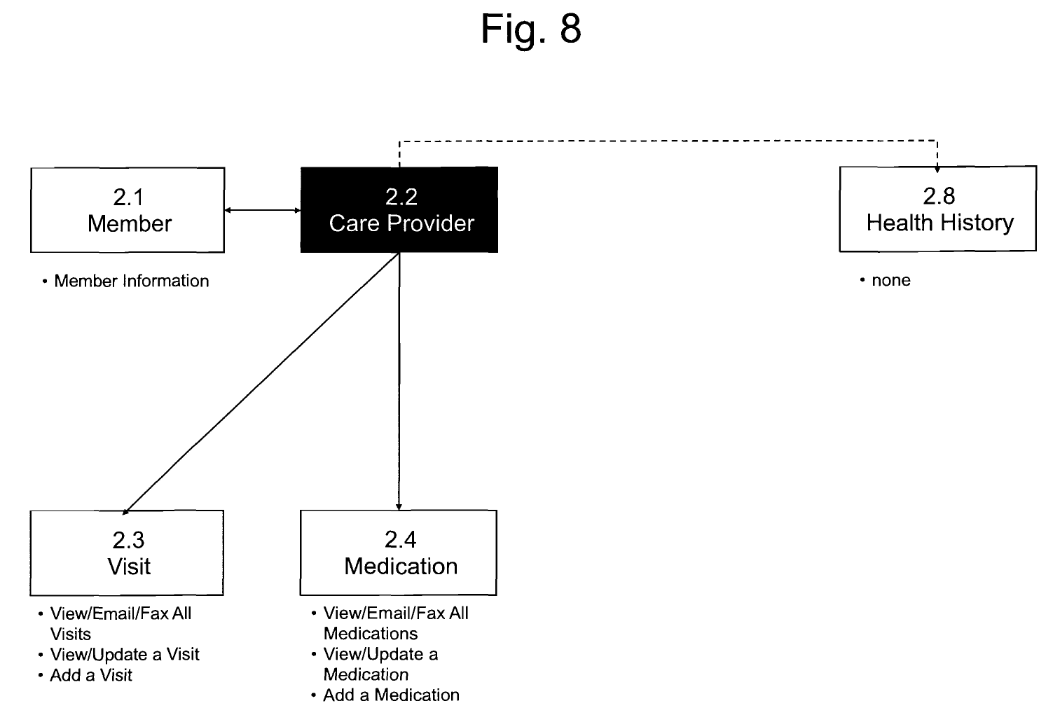

Referring now to FIGS. 5 and 8, the care provider in MHB may refer to any individual that provides health related care, such as, but not limited to, a physician, a surgeon, a dentist, a psychologist/psychiatrist, a nurse, specialist, veterinarian doctor, veterinarian surgeon, or physician/nurse assistant.

Care provider in MHB may also refer to any healthcare setting that a user may receive healthcare that is not tied to a specific individual care provider. Such settings include, but not limited to, emergency room (ER) of a hospital, an urgent care facility a retail health clinic (such as, Wal-Mart health clinic, Walgreens health clinic, etc.), or a home care agency.

Care provider is identified by his/her names, in any format of user preference, such as, but not limited to, (first last) or (last, first).

Contact information related fields of a care provider include, but are not limited to, specialty, work phone number, emergency phone number, cell phone number, fax number, work address 1, work address 2, email address 1, email address 2, website1, website 2, etc.

Insurance co-pay information may be captured for a care provider.

Different care providers may be associated with a same member. Additionally, different members may be associated to a same care provider.

When a user enters a new care provider, as the user types the name, MHB will prompt any existing Care provider in its repository that matches the typed entries. If an existing care provider is selected by the user, MHB will populate all other fields with the data retrieved from its repository, and user's new entries would become an update to the existing care provider, instead of adding a new one.

As illustrated in FIGS. 5 and 8, the care provider block 2.2 carries out at least the following functions:

Automatic Contact Synchronization function . . . MHB will automatically synchronize the care provider's information with the mobile device's contact management program, or with the information retrieved from internet search engine so update(s) either to the care provider information in MHB or directly to a contact in the mobile device are reflected both real-time.

Call/SMS function . . . without leaving a care provider's page, a user may choose the option (either a button or a drop-down menu item) to call/SMS this care provider using any of this care provider's phone numbers, and return to the same care provider's page after the Call/SMS.

Email/Fax/Instant Messaging function . . . without leaving a care provider's page, a user may choose the option (either a button or a drop-down menu item) to email/fax this care provider using any of this care provider's email addresses or fax number, and return to the same care provider's page after the Email/Fax/Instant Messaging. Complete or partial content of a member's record may be emailed/faxed to this care provider, such as, but not limited to, a log of allergy occurrence, symptoms and actions taken.

Map/GPS function . . . without leaving a care provider's page, a user may choose the option (either a button or a drop-down menu item) to map this care provider using any of this care provider's addresses, and return to the same care provider's page after the Map/GPS.

Web Link function . . . without leaving a care provider's page, a user may choose the option (using a button, a drop-down menu item, or by touching the name on the screen) to link to this care provider's website using any of this care provider's website URLs, and return to the same care provider's page afterwards.

Member Information function . . . on a care provider page, a user may choose the option (either a button or a menu item) to list all members that are associated with this particular care provider; and choose any one member to retrieve the detailed member information.

View/Email/Fax All Visits function . . . on a care provider's page, a user may choose the option (either a button or a menu item) to list all visits associated to this particular care provider, which may be, but not limited to, historical or upcoming visits, from one or multiple members, and within a user specified time period. A user may choose any particular visit to continue to View/Update a Visit. A user may also choose the option (either a button or a menu item) to email/fax all visit details to user specific email/fax recipient(s).

View/Update a Visit function . . . a user may review the information of a previously entered visit, and make changes on the individual visit page.

Add a Visit function . . . on a care provider's page, a user may choose the option (either a button or a menu item) to add a new visit that's associated with this particular care provider. MHB will bring the user to the screen to add a new visit that is pre-populated with the member and care provider information.

View/Email/Fax All Medications function . . . on a care provider's page, a user may choose the option (either a button or a menu item) to list all medications recommended by this particular care provider, which may be, but not limited to, current and past medications, prescription or over-the-counter, and within a user specified time period. A user may choose any particular medication to continue to View/Update a Medication. A user may also choose the option (either a button or a menu item) to email/fax all medication details to user specific email/fax recipient(s).

View/Update a Medication function . . . a user may review the information of a previously entered medication, and make changes on the individual medication page.

Add a Medication function . . . on a care provider's page, a user may choose the option (either a button or a menu item) to add a new medication that's associated with this particular care provider. MHB will bring the user to the screen to add a new medication that is pre-populated with the care provider's information.

Add Attachment function . . . on a care provider's page, a user may choose the option (either a button or a menu item) to add an attachment file, which may be, but not limited to, text file, binary file, image file, video file, sound file, etc., that will be associated to this particular care provider. User may also include a text description of the attachment.

View/Listen/Update Attachment function . . . on a care provider's page, a user may choose the option (either a button or a menu item) to view/update any one of the attachment files that are associated to this particular care provider. User may also view/listen/update the text description of the attachment.

Share Attachment function . . . on a care provider's page, a user may choose the option (either a button or a menu item) to send any one or multiple attachment file(s) that are associated to this particular care provider to any email recipient(s).

Delete Attachment function . . . on a care provider's page, a user may choose the option (either a button or a menu item) to delete any one of the attachment files that are associated to this particular care provider.

Edit/Delete Myself function . . . on a care provider's page, a user may choose the option (either a button or a menu item) to edit this particular care provider's information, or delete this particular care provider from MHB.

The visit block 2.3 shown in FIG. 4 provides at least the following information relating to the member/owner of the mobile devices including the MHB. This visit information includes, but is not limited to:
Visit date, start time and duration
Member name
Care provider name
Visit type
Visit short description
Visit detailed description
Visit care recommendation
Visit cost information.
Test Results or measurements related to the visits.

The visit information block 2.3 shown in FIG. 4 allows a user to capture the information during a member's visit to a care provider. Visits may be what has happened, what is happening, or what is scheduled to happen in the future.

Visits, in real life, could be any visit to a doctor's office, a clinic, an outpatient surgery center, or a hospital ER, an urgent care facility, an eye check room from a retail store. MHB is not intended to manage any aspects of an inpatient hospital stay. However MHB can retrieve any relevant parameters tracked during an inpatient stay.

A visit in MHB is identified by the combination of member, care provider/facility (in case or ER/Urgent Care or outpatient center) and date/time. The Care provider field may be used to capture the name of a care provider in MHB. When a user enters a care provider name, as the user types the care provider name, MHB will prompt any existing care provider in its repository that matches the typed entries. If a prompted existing care provider is selected by the user, MHB will automatically associate this visit with this particular care provider, so all visits associated with any particular care provider may be retrieved together. If the user enters a new care provider name, MHB will automatically create a new care provider with minimum information, i.e., his/her name. User may provide more details of this new care provider on a care provider page.

The Visit type field may be used to specific such a visit is scheduled, unscheduled or emergency. MHB will provide default value for the visit type based on the timing of the visit, such as, but not limited to, ‘scheduled’ for a visit after 24 hours, ‘unscheduled’ for a visit on the same day, and ‘emergency’ for a visit that's happening or happened. User may overwrite the default value suggested by MHB. MHB will automatically have a calendar entry, for a scheduled or unscheduled visit, on the mobile device's built-in calendar.

Visit short description field may be used to capture a summary of the visit, for easy retrieval and/or display in the future. Some examples are ‘12 month wellness checkup’, ‘annual checkup’, ‘high fever, after-hour doctor phone call’, and ‘ear infection follow-up’. The auto-prompt function will be use which is combined with the other criteria. For example, if the user enter wellness checkup, MHB will auto prompt wellness check and add the Age information in the title based on the current age, the dates of the wellness check up

Visit detailed description field may be used to capture more detailed information about this visit, such as detailed symptoms and diagnosis.

Visit care recommendation field may be used to separately capture the care recommendations from the care provider during the visit. A user may leave this field blank when a visit is first scheduled, and MHB will not display this field for a visit scheduled in the future. Some examples are ‘only water, no soap, on skin’, ‘change bandage twice a day, morning & evening’ and ‘change body position every 2 hours’, check blood sugar, install IV. This field is not intended to capture medication related recommendations, prescription or over-the-counter. Medication shall be captured in a medication object.

Visit cost information related fields may include, but not limited to, charged amount, discount amount, insurance coverage, out-of-pocket amount, etc. The visit cost may be retrieved from the member health insurance company's online server.

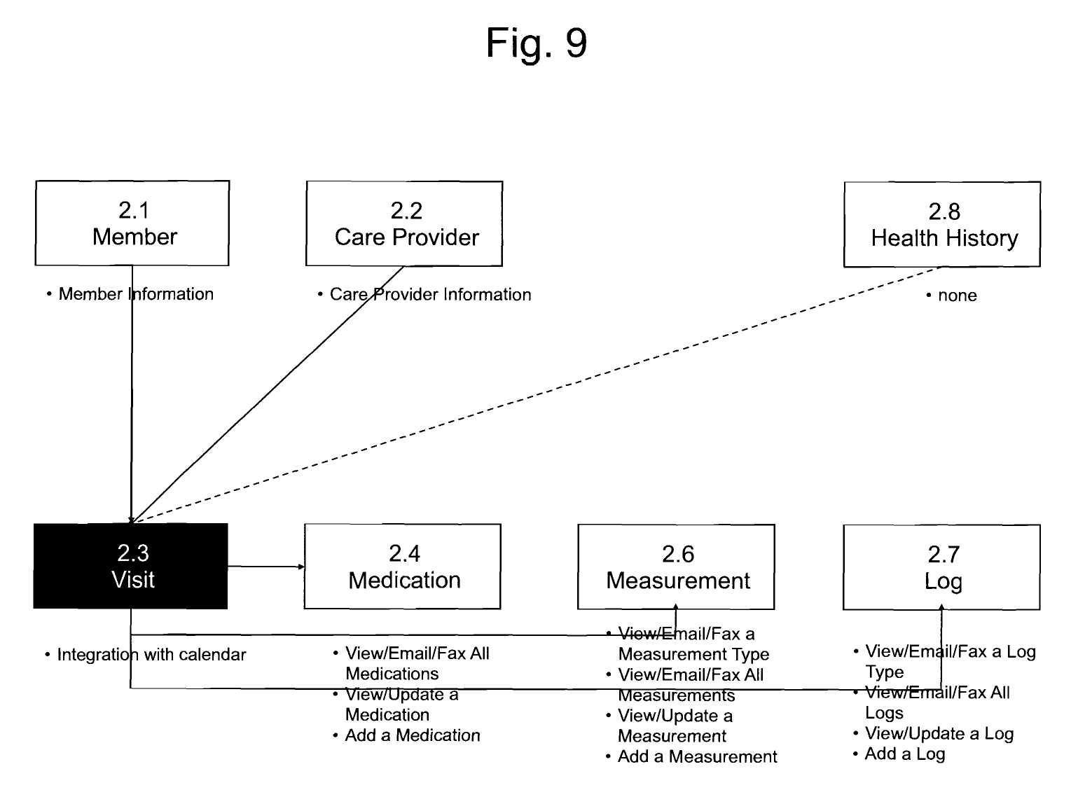

As shown in FIG. 9, the main feature of the Visit Block 2.3 include at least the following:

Member Information function . . . on a visit page, a user may choose the option (either a button or a menu item) to go to the detailed member page that is associated with this particular visit.

Care provider Information function . . . on a visit page, a user may choose the option (either a button or a menu item) to go to the detailed care provider page that is associated with this particular visit.

View/Email/Fax all medications function . . . on a visit page, a user may choose the option (either a button or a menu item) to list all medications associated to this particular member, which may be, but not limited to, current and past medications, recommended by one or multiple care providers, prescription or over-the-counter, associated to this particular visit or not, and within a user specified time period. A user may choose any particular medication to continue to View/Update a Medication. A user may also choose the option (either a button or a menu item) to email/fax all medication details to user specific email/fax recipient(s).

View/Update a Medication function . . . a user may review the information of a previously entered medication, and make changes on the individual medication page.

Add a Medication function . . . on a visit page, a user may choose the option (either a button or a menu item) to add a new medication, prescription or over-the-counter, that's recommended by the care provider at this particular visit. MHB will bring the user to the screen to add a new Medication that is pre-populated with the member and care provider information, and internally associate this visit to the new medication for future information retrieval purpose.

View/Email/Fax a Measurement/test results Type function . . . on a visit page, a user may choose the option (either a button or a menu item) to view a certain type of measurement/test results associated to this particular member. MHB will group all measurements or test results by measurement types, and list all available measurement types. A user may choose any particular measurement type to review all previously entered measurements of the same measurement type, and choose any particular measurement to continue to View/Update a Measurement or test result. A user may also choose the option (either a button or a menu item) to email/fax all measurement details of the same measurement type to user specific email/fax recipient(s).

View/Email/Fax All Measurements/test results function . . . on a visit page, a user may choose the option (either a button or a menu item) to list all measurements associated to this particular member during a user specified time period (such as, this week). A user may choose any particular measurement to continue to View/Update a Measurement/test result. A user may also choose the option (either a button or a menu item) to email/fax all measurement details of the user specified time period to user specific email/fax recipient(s).

View/Update a Measurement/test results function . . . a user may review the information of a previously entered measurement of a member, and make changes on the individual measurement page.

Add a Measurement/test results function . . . on a visit page, a user may choose the option (either a button or a menu item) to add new measurement/test results, that's captured during this particular visit for this particular member. MHB will bring the user to the screen to add a new measurement with the member information pre-populated. In real life application, such measurement could be temperature, weight, height, blood pressure, vaccination, blood test results, urine test results, etc.

View/Email/Fax a Log Type function . . . on a visit page, a user may choose the option (either a button or a menu item) to view a certain type of log associated to this particular member. MHB will group all logs by log types, and list all available log types. A user may choose any particular log type to review all previously entered logs of the same log type, and choose any particular log to continue to View/Update a Log. A user may also choose the option (either a button or a menu item) to email/fax all log details of the same log type to user specific email/fax recipient(s).

View/Email/Fax All Logs function . . . on a visit page, a user may choose the option (either a button or a menu item) to list all logs associated to this particular member during a user specified time period (such as, this week). A user may choose any particular log to continue to View/Update a Log. A user may also choose the option (either a button or a menu item) to email/fax all log details of the specified time period to user specific email/fax recipient(s).

View/Update a Log function . . . a user may review the information of a previously entered log of a member, and make changes on the individual log page.

Add a Log function . . . on a visit page, a user may choose the option (either a button or a menu item) to add a new log that's associated with this particular member. MHB will bring the user to the screen to add a new log that is pre-populated with the member's information.

Calendar Integration function . . . MHB will automatically synchronize a visit with the mobile device's calendar management program, using, but not limited to, one of the following ways:
When a new ‘scheduled’ or “unscheduled” visit is first created in MHB, MHB synchronizes with the mobile-device's calendar management program way.
For a ‘scheduled’ or ‘emergency/unscheduled’ visit, a new visit entry is created, with at least, but not limited to, the following information derived from the visit: date, start time, duration, member name, care provider name, short description, care provider address, phone number, and a map link to the this care provider's address.
For a visit scheduled in the future, a new calendar entry is created in the calendar management program of the mobile device, and standard calendar reminder function is expected to work for the user. And this scheduled visit appears in this member's To-Do Reminder List.
For an emergency visit that a user creates in MHB, no integration happens (i.e., no calendar entry may be created) with the mobile device's calendar.
MHB automatically synchronizes any update to either the visit entry in MHB or the corresponding calendar entry in the mobile device's calendar.
When a health-related visit is either first created or later updated in the mobile-device's calendar, MHB synchronizes the scheduled visit in the following way.
MHB receives new calendar entries that are scheduled for the future, as the calendar entries are created in the Calendar. Using advanced sentence and word processing, MHB will ignore all non-health related calendar entries, and focus on potential health related entries.
MHB automatically processes all potential health related calendar entries, and extracts information (such as, but not limited to, date/time, location, subject, etc.) from those calendar entries into potential MHB scheduled visits. For example, MHB may locate a member name in the subject line of a calendar entry, and associate this visit with this member, the visit type based on the title and the care provider information. Another example, if the location of a calendar entry is in the form of street address, using the Geographic Locator function of the mobile device, MHB may be able to associate this visit with a care provider at that address.
The user, upon getting to the MHB's main page, will be prompted to review only those potential scheduled visits that MHB has extracted from potential health-related calendar entries but could not resolve automatically, due to either data conflict or incompleteness. MHB will pre-populate fields of the visit using information from the mobile-device's calendar entry and/or existing MHB visit entries, and allow the user to update and choose, and decide if to add a new visit or update an existing visit in MHB.
For the scheduled visits MHB extracts from calendar entries with completeness and data consistency, MHB will automatically create a new or update an existing visit.

Auto-Prompt function . . . when applicable, MHB will automatically prompt any individual entry field with value that most logically matches the already known information.

Auto-Spelling function . . . as a user types in any individual entry field, MHB will automatically check the spelling and propose correct spelling when needed.

Add Attachment function . . . on a visit page, a user may choose the option (either a button or a menu item) to add an attachment file, which may be, but not limited to, text file, binary file, image file, video file, sound file, etc., that will be associated to this particular visit. User may also include a text description of the attachment.

View/Listen/Update Attachment function . . . on a visit page, a user may choose the option (either a button or a menu item) to view/listen/update any one of the attachment files that are associated to this particular visit. User may also view/update the text description of the attachment.

Share Attachment function . . . on a visit page, a user may choose the option (either a button or a menu item) to send any one or multiple attachment file(s) that are associated to this particular visit to any email recipient(s).

Delete Attachment function . . . on a visit page, a user may choose the option (either a button or a menu item) to delete any one of the attachment files that are associated to this particular visit.

Edit/Delete Myself function . . . on a visit page, a user may choose the option (either a button or a menu item) to edit this particular visit's information, or delete this particular visit from MHB.

The medication block 2.4 of the MHB, as shown in FIG. 4, includes at least the following information, but may included additional information as required.
Medication name
Member name
Care provider name
Medication recommendation date
Last fill date
Number of refills remaining
Next fill date
Medication direction
Medication info URL
Medication cost information
Alternative or price comparison info
Warning information relating to drug interactions or drug/member condition interaction

The medication block 2.4 shown in FIG. 4 may be used for both prescription and over-the-counter products. The medication name may be used to capture the drug's scientific name, brand name, national drug code (NDC) or just a general description of user preference. For example, a user may enter Amoxicillin Oral (a scientific name), Amoxil (a brand name), or simply antibiotics pill (a general description of user preference), for the same drug. MHB will give warning to the user if only a general description is entered, as it is strongly preferred that a user uses a scientific or brand name for a medication.

The care provider field may be used to capture the name of a care provider in MHB that recommends this medication. When a user enters a care provider name, as the user types the care provider name, MHB will prompt any existing Care Provider in its repository that matches the typed entries. If a prompted existing care provider is selected by the user, MHB will automatically associate this medication with this particular care provider, so all medications associated with any particular care provider may be retrieved together. If the user enters a new care provider name, MHB will automatically create a new care provider with minimum information, i.e., his/her name. User may provide more details of this new care provider on a care provider page.

The medication recommendation date field may be used to capture the date that a care provider recommends this medication. Last fill date, next fill date and number of refills remaining together may be used to help a user manage his/her medication fill/refill activities.

Medication direction related information, such as, but not limited to, dosage, when to take medicine, frequency and duration, will be captured by MHB in the way that may be easily converted to a calendar entry in the mobile-device's calendar functionality, so MHB may send the user reminders to take medication.

Medication info URL field allow a user to enter a Web URL to a webpage that contains information about this particular medication, such as a drug information page on Google Health, WebMD, or Parent Center, etc.; or a link to another related application running on the device.

Medication cost information related fields may include, but not limited to, charged amount, discount amount, insurance coverage, out-of-pocket amount, etc.

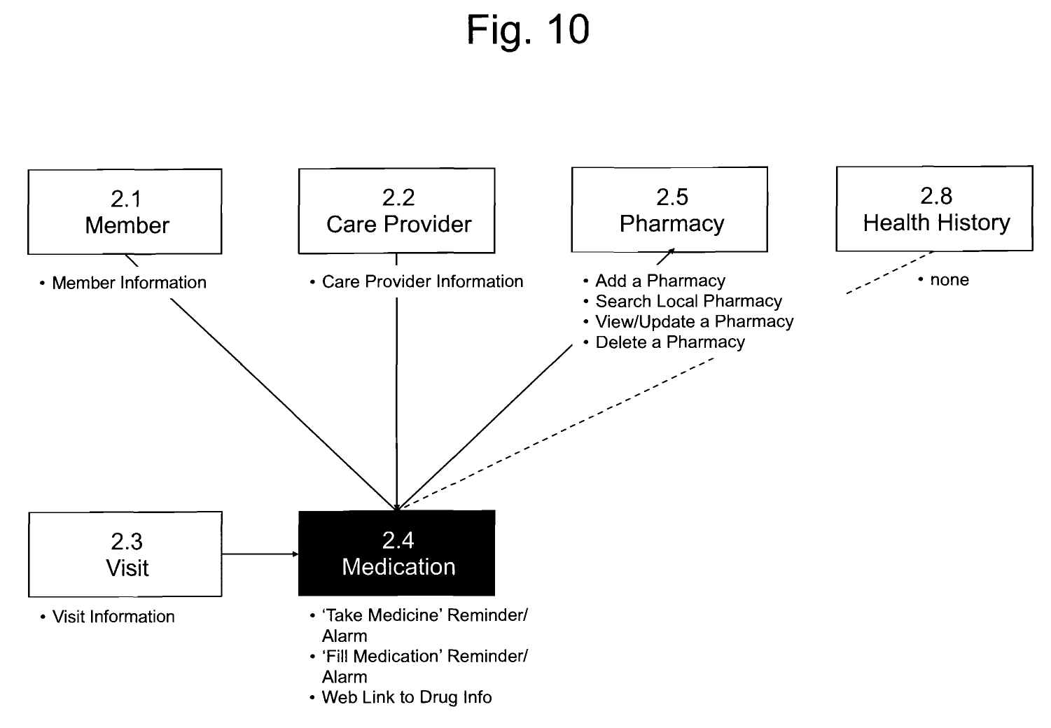

Referring now to FIG. 10, the medication block 2.4 is capable of communication with other function blocks as shown. The communication carries out at least the following features:

Member Information function . . . on a medication page, a user may choose the option (either a button or a menu item) to go to the detailed member page that is associated with this particular medication.

Care provider Information function . . . on a medication page, a user may choose the option (either a button or a menu item) to go to the detailed care provider page that is associated with this particular medication.

Visit Information function . . . if this particular medication was captured at a certain visit, on the medication page, a user may choose the option (either a button or a menu item) to go to the detailed visit page.

‘Take Medication’ Reminder function . . . on a medication page, a user may choose the option (either a button or a menu item) to easily set up reminders to take medicine using mobile device's calendar management program. MHB will automatically populate the calendar entry using the medication direction information, such as, but not limited to, member name, medication name, dosage, when to take medicine, frequency and duration. For any medication a member currently takes, a ‘take medication’ reminder will appear in this member's To-Do Reminder List. Any updates to the medication direction after the reminder is first set up, will be automatically trickled down to the calendar reminder entry by MHB.

Automatic ‘Fill Medication’ Reminder function . . . MHB automatically creates a reminder entry in the mobile device's calendar management program to remind the user of any upcoming medication fill(s)/refill(s), using the non-null next fill date field of the medication. Such reminder entry may contain, but not limited to, information such as, member name, medication name, last fill date, next fill date, pharmacy name. For any medication that a member has outstanding fill(s)/refill(s), a ‘fill medication’ reminder will appear in this member's To-Do Reminder List. Any updates to the medication's next fill date after the reminder is first set up, will be automatically trickled down to the reminder entry by MHB.

Web Link to Drug Info function . . . without leaving the medication page, a user may have the option (using a button, a drop-down menu item, or by touching the name on the screen) to link to this medication's drug information website using the medication info URL, and return to the same care provider's page afterwards.

Add a Pharmacy function . . . a user may choose the option (either a button or a menu item) to associate a pharmacy that he/she uses to fill this prescription. A user may choose a pharmacy that is in MHB repository, or from the result of the Search Local Pharmacy function below, and may continue to View/Update a Pharmacy.

Search Local Pharmacy function . . . a user may enter search criteria, such as, but not limited to, nearest location (using such as, but not limited to, city/state, ZIP/postal code, etc.), hours of operation, certain chain name(s), etc., to search for local pharmacies. MHB will return all search results (i.e., pharmacies) in the order of best matching, for the user to choose from. MHB may automatically determine the location of ‘local’ using the user's current geographic coordinates known by the mobile device, and/or using user's direct inputs.

View/Update a Pharmacy function . . . without leaving the medication page, a user may choose the option (either a button or a menu item) to view the complete details of the pharmacy that is already associated to this medication, and return to the same medication page afterwards.

Delete a Pharmacy function . . . without leaving the medication page, a user may choose the option (either a button or a menu item) to disassociate a pharmacy to this medication, and return to the same medication page afterwards. MHB will retain the information of the ‘deleted’ pharmacy in its repository, and simply dis-associate the pharmacy with this particular medication.

Auto-Complete function . . . as a user types in any individual entry field, MHB will automatically complete the user entry based on previously entered value(s) that match the typed entries.

Auto-Prompt function . . . when applicable, MHB will automatically prompt any individual entry field with value that most logically matches the already known information.

Auto-Spelling function . . . as a user types in any individual entry field, MHB will automatically check the spelling and propose correct spelling when needed.

Add Attachment function . . . on a medication page, a user may choose the option (either a button or a menu item) to add an attachment file, which may be, but not limited to, text file, binary file, image file, video file, sound file, etc., that will be associated to this particular medication. User may also include a text description of the attachment.

View/Update Attachment function . . . on a medication page, a user may choose the option (either a button or a menu item) to view/update any one of the attachment files that are associated to this particular medication. User may also view/update the text description of the attachment.

Share Attachment function . . . on a medication page, a user may choose the option (either a button or a menu item) to send any one or multiple attachment file(s) that are associated to this particular medication to any email recipient(s).

Delete Attachment function . . . on a medication page, a user may choose the option (either a button or a menu item) to delete any one of the attachment files that are associated to this particular medication.

Edit/Delete Myself function . . . on a medication page, a user may choose the option (either a button or a menu item) to edit this particular medication's information as described in section 2.4.1, or delete this particular medication from MHB.

Drug information entered into the medication module 2.4 contains the duration and frequency of the drug delivery. This information will be synchronized with the calendar management program of the mobile device for reminders for the user.

Presently, it is contemplated that there are three different ways to enter medication or drug information into the medication module 2.4 of the MHB. The first method is for the end user to enter all information into the medication module 2.4, including the drug name, dosage, frequency and length of prescription. Since this method requires many manual entries, the medication module 2.4 will try to match the drug information the user is entering with information that was previously entered into the MHB. For example, if Tylenol was already given to the member, the application will match this entry and copy the information from memory. The end user will have to confirm the dose and frequency upon saving if the match is selected. If Tylenol was never given to the user but was given to another member being monitored by the user of the mobile device, the match will be proposed but the end user will have to reenter the dose, time and length of prescription.

The second method of drug entry is to input the national drug code (NDC) from the medication. The MHB will recover all of the information for the drug from a national database, including the dose, recommended dose and frequency, which will default into the form. A picture of the drug will also preferably be displayed to the user.

The third type of drug entry is to utilize a camera of the mobile device to photograph the bar code of the medication. Based upon the bar code, the mobile device will process the national drug code to find the information described above. The use of a camera of the mobile device to scan a bar code is a known application for the mobile device.

Once the drug information is entered into the MHB, the MHB will check whether the drug creates possible drug interactions with other drugs being taken by the member and to determine whether the member is allergic to the drug. If the MHB finds some problem with the drug, the MHB will alert the user and propose the user called a primary care physician.

Referring back to FIG. 4, the MHB includes a pharmacy functional block 2.5 that includes at least the following information:
Pharmacy name
Pharmacy type
Contact information
Pharmacy operating hours
Medication co-pay information
Pharmacy membership account information
Pharmacy Notes.

The pharmacy functional block 2.5 of the MHB, the term pharmacy may be used to describe, but not limited to, a retail pharmacy, a mail order agency, or a web order agency. The pharmacy type field may be used to capture this information.
Contact information related fields of a pharmacy include, but are not limited to, store phone number, pharmacy phone number, fax number, address, email address, website, etc.
Medication co-pay information may be captured the drug insurance co-pay information of a pharmacy. For example, a user may have ‘generic $12, brand $25, 90-day mail order $30’.
Pharmacy membership account information is for the user to capture their own membership to this particular pharmacy, such as, but not limited to, discount card, loyalty card, etc.
When a user enters a new pharmacy, as the user types the name, MHB will prompt any existing pharmacy in its repository that matches the typed entries. If an existing pharmacy is selected by the user, MHB will populate all other fields with the data retrieved from its repository, and user's new entries would become an update to the existing pharmacy, instead of adding a new one.

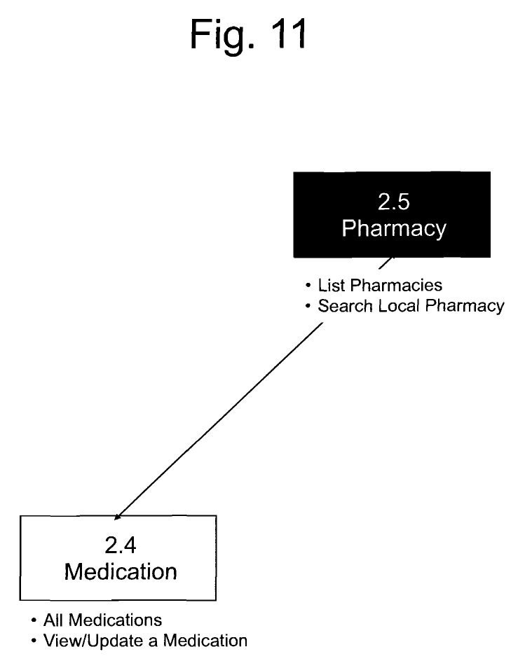

As shown in FIGS. 5 and 11, the pharmacy block 2.5 will allow the MHB will show a list of pharmacies, based on the user's choices of, but not limited to, all pharmacies in MHB (i.e., those the user used before), local pharmacies of where the user currently is (i.e., use the location positioning functionality of the mobile device first to locate the position, then use Search Local Pharmacy function below), or simply local pharmacies of a use specified location (i.e., use Search Local Pharmacy function below).

The search local pharmacy function allows a user to enter search criteria, such as, but not limited to, nearest location (using such as, but not limited to, city/state, ZIP/postal code, etc.), hours of operation, certain chain name(s), etc., to search for local pharmacies. MHB will return all search results (i.e., pharmacies) in the order of best matching, for the user to choose from. MHB may automatically determine the location of ‘local’ using the user's current geographic coordinates known by the mobile device, and/or using user's direct inputs.

The automatic contact synchronization function allows the MHB to automatically synchronize the pharmacy's information with the mobile device's Contact or Address Book applications so update(s) either to the pharmacy contact information in MHB or directly to a contact in the mobile device are reflected on both real-time.

The call function will allow the user, without leaving the pharmacy page, to either choose the option (either a button or a drop-down menu item) to call this pharmacy using any of this pharmacy's phone numbers, and return to the same pharmacy page after the phone call.

The email/fax function will allow the user, without leaving a pharmacy page, to choose the option (either a button or a drop-down menu item) to email/fax this pharmacy using any of this pharmacy's email addresses or fax number, and return to the same pharmacy's page after the email/fax. The Email fax function will be used to email a scanned Rx taken from the WEB camera to refill and fill an order

The map/GPS function will allow the user without leaving a pharmacy page, to choose the option (either a button or a drop-down menu item) to map this pharmacy using any of this pharmacy's addresses, and return to the same pharmacy's page after the Map/GPS.

The web link function will allow the user, without leaving a pharmacy's page, to choose the option (using a button, a drop-down menu item, or by touching the name on the screen) to link to this pharmacy's website using any of this pharmacy's website URLs, and return to the same pharmacy's page afterwards.

The all medications function on a pharmacy page will allow a user to choose the option (either a button or a menu item) to list all medications that are filled at this particular pharmacy, which may be, but not limited to, from one or multiple members, recommended by one or multiple care providers, and within a specified time period. A user may choose any particular medication to continue to View/Update a Medication. It allows tracking medications inventory and to avoid refill or fill a prescription if the inventory is not used.

The view/listen/update a medication function will allow a user to review or listen to the information of a previously entered medication, and make changes on the individual medication page.

The auto-complete function will allow the MHB, in any individual entry field, to automatically complete the user entry based on previously entered value(s) that match the typed entries.

The auto-prompt function when applicable, will allow the MHB to automatically prompt any individual entry field with value that most logically matches the already known information.

The auto-spelling function, as the user types in any individual entry field, allows the MHB to automatically check the spelling and propose correct spelling when needed.

The add attachment function . . . on a pharmacy page, a user may choose the option (either a button or a menu item) to add an attachment file, which may be, but not limited to, text file, binary file, image file, video file, sound file, etc., that will be associated to this particular pharmacy or a particular prescription. User may also include a text description of the attachment.

View/Listen/Update Attachment function . . . on a pharmacy page, a user may choose the option (either a button or a menu item) to view/listen/update any one of the attachment files that are associated to this particular pharmacy. User may also view/update the text description of the attachment.

Share Attachment function . . . on a pharmacy page, a user may choose the option (either a button or a menu item) to send any one or multiple attachment file(s) that are associated to this particular pharmacy to any email recipient(s).

Delete Attachment function . . . on a pharmacy page, a user may choose the option (either a button or a menu item) to delete any one of the attachment files that are associated to this particular pharmacy.

Edit/Delete Myself function . . . on a pharmacy's page, a user may choose the option (either a button or a menu item) to edit this particular pharmacy's information, or delete this particular pharmacy from MHB.

Referring again back to the diagram of FIG. 4, the MHB further includes a measurement/test results module 2.6. The measurement/test results module 2.6 includes at least the following information:
Measurement type
Member name
Measurement date/time
Measurement unit
Measurement method
Measurement value
Recorded by.
Visit/Events Link.

The measurement/test results module 2.6 in the MHB may be used to log the values of vital signs/measurements/test results for tracking and trending purposes, such as a kid's height and weight, blood pressure for elderly parents, cholesterol or diabetes. The measurement type field is for the user to specify the vital signs/measurement/test results of interest, such as, but not limited to, height, weight, temperature, blood pressure, glucose, blood work, etc. Measurements of the same type may be grouped by MHB for tracking and trending analysis.

The information entered into the measurement/test results module 2.6 can include a large variety of information relating to measurements for the user or test results for the user. This information can be entered into the measurement module 2.6 in any number of ways, such as by manual entry by the user or through measurements received from a wired or wireless device, such as a medical device. Additionally, the measurements/test results could be retrieved from a remote device or remote server. The measurements/test results thus can be received by the MHB from a plurality of sources in a series of communication methods.

The measurement unit field may be used to indicate the metrics of the measurement value, such as, but not limited to, lbs, inches, cm, kg, C, F, etc.

The measurement method field may be used to indicate the instrument or approach that is used to obtain the vital sign. For example, oral and rectal method for temperature or the type of instrument used for diabetes or blood pressure.

The measurement date/time & recorded by field may be used to capture the date, time and the person that performed or recorded this measurement. MHB will automatically populate this field with the mobile device owner's name that the user may update.

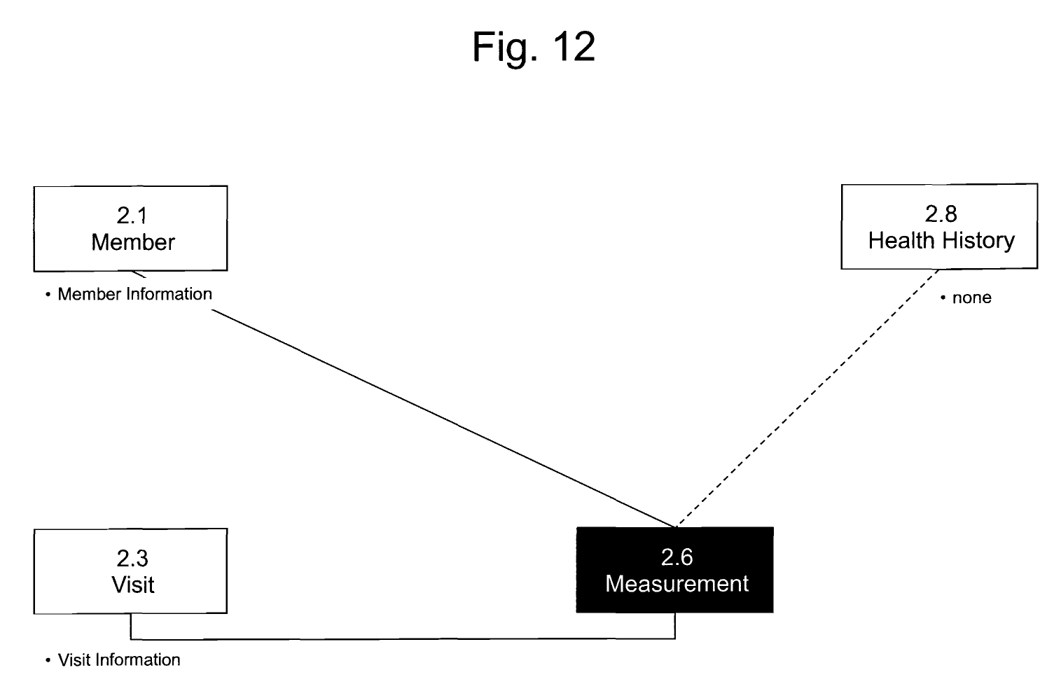

As shown in FIG. 12, the measurement/test results block 2.6 carries out a member information function on a measurement page, where a user may choose the option (either a button or a menu item) to go to the detailed member page that is associated with this particular measurement.

The visit information function is such that if this particular measurement was captured at a certain visit, on the measurement page, a user may choose the option (either a button or a menu item) to go to the detailed visit page.

The auto-complete function allow for as a user types in any individual entry field, MHB will automatically complete the user entry based on previously entered value(s) that match the typed entries.

The auto-prompt function, when applicable, MHB will automatically prompt any individual entry field with value that most logically matches the already known information.

The auto-spelling function allow for as a user types in any individual entry field, MHB will automatically check the spelling and propose correct spelling when needed.

Add Attachment function . . . on a measurement page, a user may choose the option (either a button or a menu item) to add an attachment file, which may be, but not limited to, text file, binary file, image file, video file, sound file, etc., that will be associated to this particular measurement. User may also include a text description of the attachment.

View/Listen/Update Attachment function . . . on a measurement page, a user may choose the option (either a button or a menu item) to view/listen/update any one of the attachment files that are associated to this particular measurement. User may also view/update the text description of the attachment.

Share Attachment function . . . on a measurement/test results page, a user may choose the option (either a button or a menu item) to send any one or multiple attachment file(s) that are associated to this particular measurement to any email recipient(s).

Delete Attachment function . . . on a measurement page, a user may choose the option (either a button or a menu item) to delete any one of the attachment files that are associated to this particular measurement.

Edit/Delete Myself function . . . on a measurement page, a user may choose the option (either a button or a menu item) to edit this particular measurement's information, or delete this particular measurement from MHB.

Referring back again to FIG. 4, the MHB includes the log module 2.7 which includes at least the following information:
Log type
Member name
Recorded date/time
Recorded by
Detailed log description
Next recording date/time

The log module 2.7 in the MHB may be used to keep track of any particular topic of interest, such as, but not limited to, a newborn's feeding, changing and sleeping log, a cancer patient's chemo treatment log, a post-surgery patient's pain management log, abnormal rash log, abnormal allergy reaction log, abnormal breathing or wheezing log, etc.

Log type field is for the user to specify the nature of the log, such as, but not limited to, sleeping, changing, feeding, exercising, eating, blood donation, a certain type of treatment (pain, chemo, etc.), etc. Logs of the same type may be grouped by MHB for tracking and trending analysis.

Recorded date/time & Recorded by fields may be used to capture the date, time and the person that performed or recorded this log. MHB will automatically populate this field with the mobile device owner's name that the user may update.

Detailed log description field is for the user to capture the content of the log in free format.

Next recording date/time field allows the user to set up a reminder for the next recording.

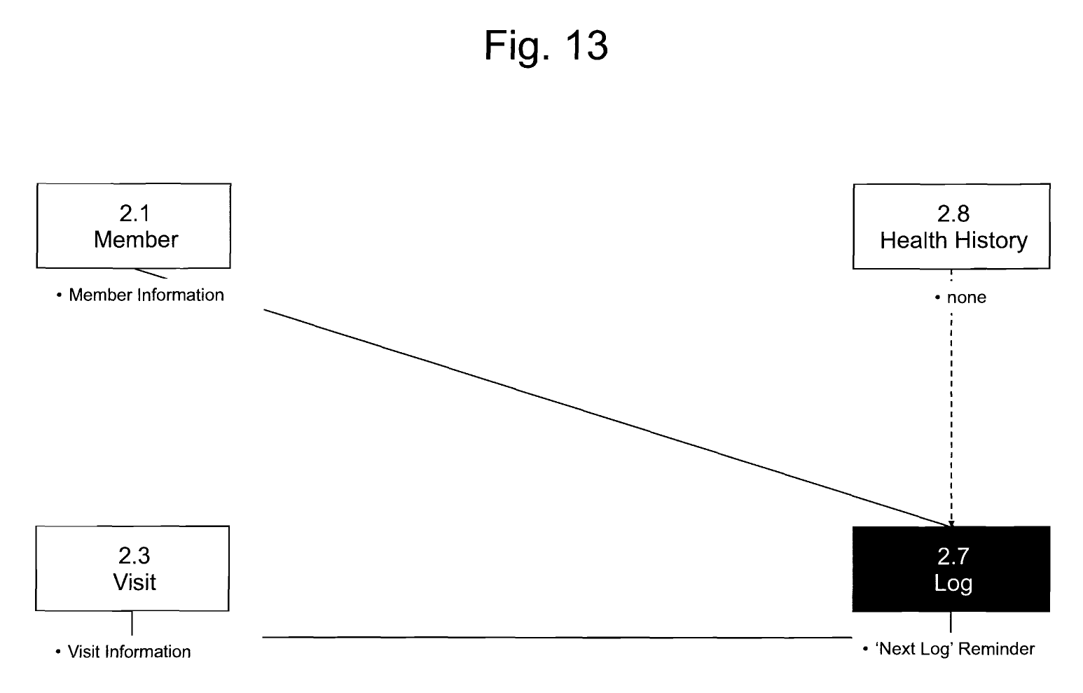

Referring now to FIG. 13, the log module 2.7 includes at least the following functions:

Member Information function . . . on a log page, a user may choose the option (either a button or a menu item) to go to the detailed member page that is associated with this particular log.

Visit Information function . . . if this particular log was captured at a certain visit, on the log page, a user may choose the option (either a button or a menu item) to go to the detailed visit page.

‘Record Next Log’ Reminder function . . . MHB will automatically set up a reminder entry in the mobile device's calendar management program using the information of a log, such as, but not limited to, member name, log type, next recording date/time. A corresponding reminder may also appear in this member's To-Do Reminder List. Any updates to the log's next recording date/time after the reminder is first set up, will be automatically trickled down to the calendar reminder entry by MHB.

Auto-Complete function . . . as a user types in any individual entry field, MHB will automatically complete the user entry based on previously entered value(s) that match the typed entries.

Auto-Prompt function . . . when applicable, MHB will automatically prompt any individual entry field with value that most logically matches the already known information.

Auto-Spelling function . . . as a user types in any individual entry field, MHB will automatically check the spelling and propose correct spelling when needed.

Add Attachment function . . . on a log page, a user may choose the option (either a button or a menu item) to add an attachment file, which may be, but not limited to, text file, binary file, image file, video file, sound file, etc., that will be associated to this particular log. User may also include a text description of the attachment.

View/Update Attachment function . . . on a log page, a user may choose the option (either a button or a menu item) to view/update any one of the attachment files that are associated to this particular log. User may also view/update the text description of the attachment.

Share Attachment function . . . on a log page, a user may choose the option (either a button or a menu item) to send any one or multiple attachment file(s) that are associated to this particular log to any email recipient(s).

Delete Attachment function . . . on a log page, a user may choose the option (either a button or a menu item) to delete any one of the attachment files that are associated to this particular log.

Edit/Delete Myself function . . . on a log page, a user may choose the option (either a button or a menu item) to edit this particular log's information or delete this particular log from MHB.

In addition to the logged information described above, the MHB allows the user to log symptoms the user is experiencing, such as a rash or wheezing sound when the user breathes. Since the mobile device typically includes a camera, the MHB allows the user to use the mobile device camera to take a picture and add notes to the picture regarding the symptoms the user is experiencing. In addition to taking a still photograph, the mobile device camera can be used to record a short movie of the symptoms with audio tracks. Likewise, since many mobile devices include a microphone, the user can utilize the MHB to enter audio evidence.

Referring back again to FIG. 4, the MHB includes a health history module 2.8 that, if and when desired by both the user and the member, allows the user to keep comprehensive health history of the member always at hand, i.e., on their mobile device. This capability will be extremely desired in the event of a trauma or an emergency situation, or in preparation/planning for major surgery or treatment, such as, but not limited to, cancer treatment, transplant or blood transfusion procedures.

MHB provides multiple ways for users to capture health history information onto the mobile device, such as, but not limited to:
Data transfer from MHB Web Portal 28, as shown in FIG. 1, which has simple forms for users to enter and store health history information;
Data transfer from member's existing online or computer based PHR 24
Data transfer from MHB Web Portal 28, which interfaces directly with other Healthcare IT systems/applications 30, such as, but not limited to, an EHR, EMR, etc., that contains member's health history information. Proper authentication and authorization of the users is required for them to use this capability
Data entry directly into MHB on the mobile device by the user.
Data transfer from MHB application from another device.

MHB's health history information is organized by type, each a health history type. Each MHB health history information entry is a health history item, each item is of a health history type.

A health history item of health history type 1, major illness, chronic conditions, infectious diseases, childbirths may be, but not necessarily or limited to, the following format:
Member name
Illness/condition name
Date diagnosed
Care provider name(s) & role(s)
Date of onset
Treatment plan
Current condition status
Remarks.

A health history item of health history type 2, immunizations, may be, but not necessarily or limited to, the following format:
Member name
Vaccine name
Vaccine # . . . such as, but not limited to, first shot, booster 1, booster 2, booster 3
Date/Time
Reason for immunization . . . such as, but not limited to, required, travel, elective/preventive, seasonal, etc.
Location of administration.

A health history item of health history type 3, allergies, may be, but not necessarily or limited to, the following format:
Member name
Allergy source
Sensitivity type . . . such as, but not limited to, medication, food, environment, or others
Confirmed or suspected
Symptom description
Symptom severity
Treatment action
Occurrence(s) . . . date/time, duration and remarks for each occurrence.

A health history item of health history type 4, family history, may be, but not necessarily or limited to, the following format:
Member name
Family member relationship . . . such as, but not limited to, father, mother, sibling(s), grandparents, children, etc.
Major illness name(s)
If deceased, cause of death & age.

A health history item of health history type 5, lifestyle, may be, but not necessarily or limited to, the following format:
Member name
Lifestyle habit type . . . such as, but not limited to, alcohol, smoking, exercise
Frequency . . . such as, but not limited to, x times/week, or x times/month, etc.
Since year.

A health history item of health history type 6, hospitalization, may be, but not necessarily or limited to, the following format:
Member name
Admission date
Discharge date
Hospital name
Care provider name(s) & role(s);
Reason;
Diagnosis;
Complications

A health history item of health history type 7, lab/imaging history, may be, but not necessarily or limited to, the following format:
Member name
Test type . . . such as, but not limited to, blood test, urine test, x-ray, MR, CT, ultrasound, etc.
Care provider name(s) & role(s)
Date/time
Reason
Result/diagnosis
Location of administration.

A health history item of health history type 8, medical device history, may be, but not necessarily or limited to, the following format:
Member name
Device type . . . such as, but not limited to, pacemaker, stent, etc.
Care provider name(s) & role(s)
Start date
End date
Reason/diagnosis
Remarks
Location of administration

A health history item of health history type 9, physical/occupational therapy, may be, but not necessarily or limited to, the following format:
Member name
Care provider name& role(s)
Therapy type
Start date
Stop date
Frequency

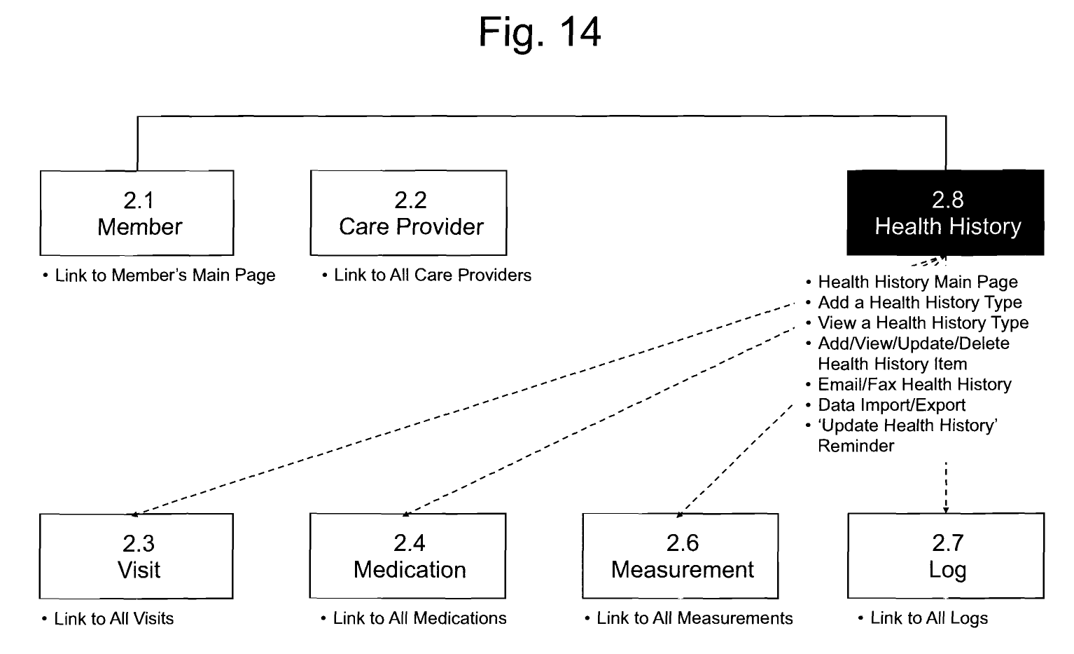

As shown in FIG. 14, the health history module 2.8 relates to other blocks in the MHB. Specifically, on the health History Main Page, the MHB lists every non-null health history type in the format of either buttons or list items. MHB also provides direct links to this particular member's main page, all care providers, all visits, all medications, all measurements and all logs.

Add a Health History Type function . . . on health history main page, a user choose the option (either a button or a menu item) to add a new health history type that has not been previously added.

View a health History Type function . . . on health history main page, a user may choose the option (either a button or a menu item) to view the complete listing of any non-null health history type, to import new health history type

Add/View/Update/Delete health History Item function . . . on the page of any particular health history type, a user may choose the option (either a button or a menu item) to add a new health history item in the format described; or choose any one health history item from the listing and view/update the information in the format described, or choose any one medical history item from the listing and delete it from MHB.

Email/Fax health History function . . . on health history main page and/or any particular medical history type page, a user may choose the option (either a button or a menu item) to email/fax complete or partial health history information to any email recipient(s).

Automatic ‘Update health History’ Reminder function . . . MHB automatically sets up a To-Do Reminder entry, which will appear in this member's To-Do Reminder List, the MHB user's calendar and this member's calendar management program on his own mobile device and any other user's calendar managing the member health, if/when no update has been made to this member's health history for a period of time, such as, but not necessarily, 90 days. MHB also automatically creates a reminder entry in the mobile device's calendar management program to remind the user to update this member's health history information.

Auto-Complete function . . . as a user types in any individual entry field, MHB will automatically complete the user entry based on previously entered value(s) that match the typed entries.

Auto-Prompt function . . . when applicable, MHB will automatically prompt any individual entry field with value that most logically matches the already known information.

Auto-Spelling function . . . as a user types in any individual entry field, MHB will automatically check the spelling and propose correct spelling when needed.

Add Attachment function . . . on a particular health history item page, a user may choose the option (either a button or a menu item) to add an attachment file, which may be, but not limited to, text file, binary file, image file, video file, sound file, etc., that will be associated to this particular health history item. User may also include a text description of the attachment.

View/Listen/Update Attachment function . . . on a particular health history item page, a user may choose the option (either a button or a menu item) to view/listen/update any one of the attachment files that are associated to this particular health history item. User may also view/update the text description of the attachment.

Share Attachment function . . . on a particular health history item page, a user may choose the option (either a button or a menu item) to send any one or multiple attachment file(s) that are associated to this particular health history item to any email recipient(s).

Delete Attachment function . . . on a particular health history item page, a user may choose the option (either a button or a menu item) to delete any one of the attachment files that are associated to this particular health history item.

For privacy reason, MHB may require a user to provide identification confirmation before a user is allowed entry. Identification confirmation methods may include, but not limited to, user-id/password or simple question automatically derived from MHB records.

Upon arriving MHB Main Page, a user may see a rolling list of members that have been previously added, with a to-do symbol highlighting those members who have open to-do reminders. User may choose any particular member to go directly to the Member's Main Page. User may click the to-do symbol to go directly to a particular member's To-Do Reminder List. User may choose the option (using either a button or a menu item) to go to Add a Member function.

On MHB Main Page, a user may also see the options (either buttons or menu items) to be connected to MHB-Web-Portal, a Web based application that provides application connectivity, data sharing and data analysis capability.

The main page of the MHB allows a user to add a new member's information in the format previously described. The main page includes a To-Do Symbol. When the symbol is depressed, the MHB will automatically scan all open to-do reminders in its repository. If a member has open to-do reminders within the user specific time period (MHB uses default value in absence of user choice), the to-do symbol will appear next to this particular member. User may click the to-do symbol to go to this member's To-Do Reminder List.

The MHB will show the complete list of a particular member's to-do reminders, in the order from the most recent to the least. Such to-do reminder may be, but not limited to, a scheduled visit, a ‘take medication’ reminder, a ‘fill medication’ reminder, a ‘record next log’ reminder, an ‘update health history’ reminder, etc. Only one upcoming ‘take medication’ reminder may appear in the To-Do Reminder List for the same medication/member/last fill date. For example, Sam is scheduled to take Aleve every day at 8 am and 6 pm for 5 days. At any given time, only the next upcoming reminder may appear in Sam's To-Do Reminder List, not more. Depending on the type of to-do reminder, each reminder may include, but not limited to, following information:
A scheduled visit . . . visit date/start time/duration, member name, care provider name/address/phone, visit short description
A ‘take medication’ reminder . . . member name, medication name, medication direction (dosage, when to take medicine, etc.), pharmacy name
A ‘fill medication’ reminder . . . member name, medication name, last fill date, next fill date, pharmacy name
A ‘record next log’ reminder . . . member name, log type, last recorded date/time, next recording date/time
An ‘update health history’ reminder . . . member name, last-update-date of the health history.
An monitor condition reminder.
An monitor vital signs or measurement reminder

Reminder Follow-Up function . . . on a member's To-Do Reminder List, a user may choose to go to any particular to-do reminder's detailed page. On each to-do reminder page, user may review the detailed information, and choose ‘Completed’, ‘Ignore Reminder’ or ‘Keep Reminder’ action to the reminder, before returning to the To-Do Reminder List. Depending on the user's action choice, MHB may perform, but not limited to, the following:
‘Completed’ . . . depending the type of reminder, MHB may perform one of the following:
A scheduled visit . . . no other action may be taken. User may go directly to the visit page to update/view the visit and related information.
A ‘take medication’ reminder . . . no other action may be taken. MHB may continue to display the next upcoming ‘take medication’ reminder, if there is any remaining, on the member's To-Do Reminder List.
A ‘fill medication’ reminder . . . if the associated medication still has refills remaining, MHB will automatically make a copy of the associated medication, adjust the number of refills remaining field, and prompt the user to update the last fill date and next fill date fields, which may or may not create another ‘fill medication’ reminder.
A ‘record next log’ reminder . . . no other action may be taken. User may directly use Add a Log to capture the completed activity, which may or may not create another ‘next log recording’ reminder.
An ‘update health history’ reminder . . . no other action may be taken. User may have gone directly to the health history page and updated the health history information.
‘Dismiss Reminder’ . . . the reminder will simply be dismissed, with no further action taken.
For an ‘update health history’ reminder, ‘Dismiss Reminder’ option will instead read as ‘No Update Needed’. MHB will update the last update date of health history and dismiss the reminder.
‘Keep Reminder’ . . . the reminder will remain in the To-Do Reminder List.

Upon arriving a Member's Main Page, a user may, but not limited to, see the following information:
Summary of Member Information, which may include, but not limited to:
   Member name
   Important demographic or physiologic parameters, such as, but not limited to, age, birth date, gender, height, weight, etc.
   Insurance information
Buttons or menu items for the user to, but not limited to, perform the following actions:
   Call the member
   SMS the member
   Email the member
   Fax the member
   Map the member
   Instant Messaging with the member

If this member has open to-do reminders, a to-do symbol that the user may click to bring up this member's To-Do Reminder List.

A combined list of this member's complete history of visits, medications, measurements/test results and logs (each as an item), in the order from the most recent to the least. Given the size of a mobile device, it is expected only the most recent few items may be displayed at any time, for example, but not necessarily, 5 items at any time. The order may also depends on the most recent to least recent related to a care episode that the member is being monitored and treated User may use the scrolling function of MHB to scroll up/down the listing. Each item may be displayed in a summary format so user may choose/click on a particular item to continue to this item's detailed page directly. The summary format of each item may be, but not limited to, the following, depending on the type of the item:
Visit . . . date/start time, short description and care provider name
Medication . . . medication name, last fill date, next fill date (if not null), and a sign/symbol showing this medication is currently taken by the member (derived automatically from medication direction and last fill date by MHB)
Measurement . . . measurement type, date/time, measurement value/unit/method
Log . . . log type, date/time, detailed description, next recording date/time

Buttons or menu items that include, but not limited to, the following, so user may choose/click and go to the complete listing of each type of items, in the order from the most recent to the least.
Care providers . . . where user may choose/click any particular care provider to continue with all functions.
Pharmacies . . . where user may choose/click any particular pharmacy to continue with all functions.
Visits . . . where user may choose/click any particular visit to continue with all functions
Medications . . . where user may choose/click any particular medication to continue with all functions.
Measurements . . . where user may choose/click any particular measurement to continue with all functions.
Logs . . . where user may choose/click any particular log to continue with all functions.
A buttons or a menu item so user may choose/click and go to the Health History and continue with all functions.

MHB may be used by a single user independently, householder users jointly with periodic data sharing, or multiple users jointly and remotely with real-time data sharing and synchronization.

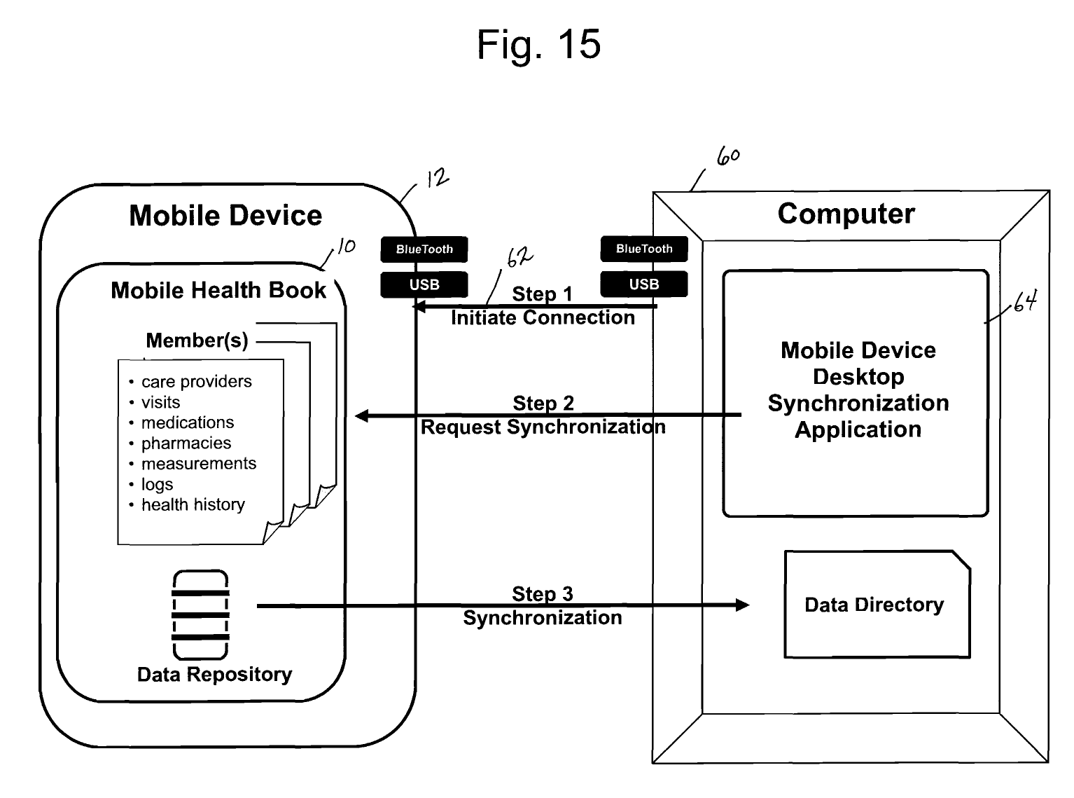

As described above with reference to FIG. 2, with the features of the MHB, as well as the mobile device's Calendar 20, Task 22, Note Pad and Contact Address Book applications 18, the MHB 10 is a powerful consumer healthcare workflow application for a single user. A single user would use Mobile-to-PC (M2P) Connectivity, as shown in FIG. 15, for MHB application installation/maintenance/archiving needs.

The MHB 10 on the mobile device 12 interacts with a PC 60 (Personal Computer, for the purpose of simplicity, in this document, also includes Mac) in the same way as other applications that run on mobile device 12, usually through the mobile device's standard Desktop Manager application. As an illustrative example, the MHB 10 can synchronize through conventional software on the PC 60, such as but not limited to iTunes® software available from Apple.

A physical link 62 is usually, but not necessarily, required to connect the hand-held mobile device and a PC. Once the connection is established, and the mobile device's Desktop Manager application 64 is activated from the PC 60, user may perform functions such as, but not limited to, the following:
MHB installation/upgrade . . . to do so, user first downloads MHB application onto PC, then installs the application onto the mobile device
MHB data backup & restore, for disaster recovery
MHB data archiving, to archive/store order data
MHB data migration, from one mobile device to another
MHB application upgrade from an older version to a new one, while maintaining existing data
MHB data synchronization with PC desktop applications, such as, but not limited to, Microsoft Office Outlook, Microsoft Office Excel, etc.

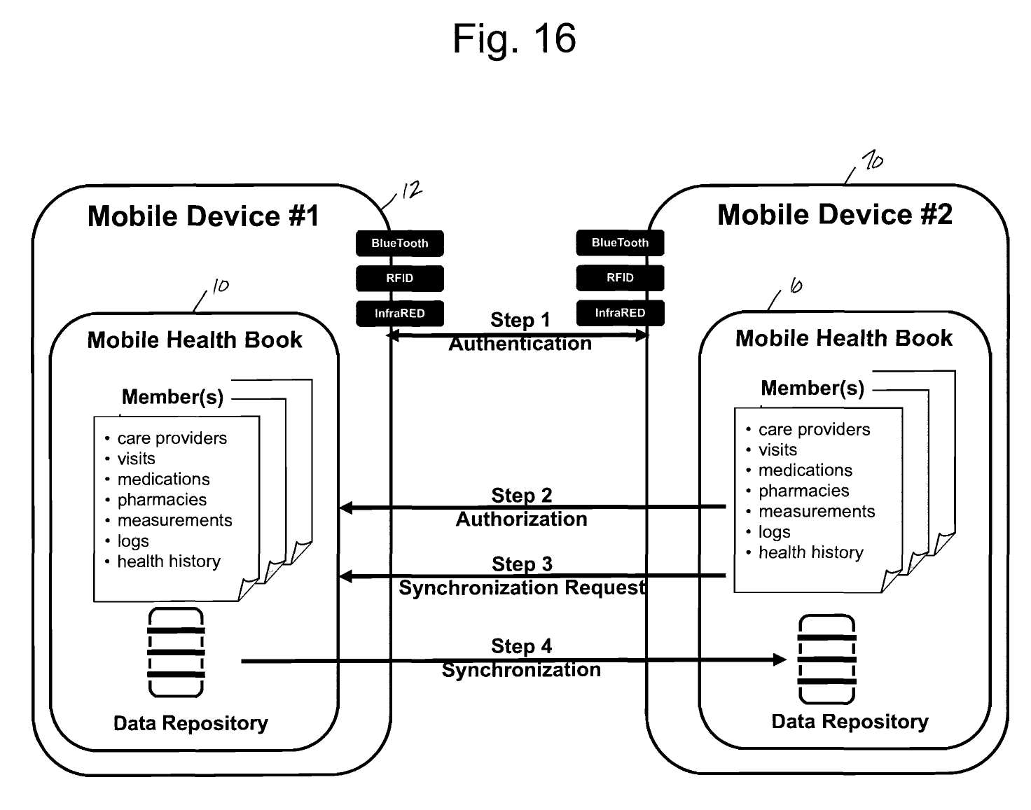

In addition to the use by an individual user, MHB users, who are usually in close proximity, such as, but not limited to, those living in the same household, or those who see each other regularly, may jointly manage member(s)' health using MHB's Mobile-to-Mobile (M2M) data sharing and synchronization capability between a first mobile device 12 and a second mobile device 70, as shown in FIG. 16. M2M Connectivity turns MHB into a consumer healthcare workflow application for multiple users.

These users may also use the M2P Connectivity shown in FIG. 15 for their MHB application installation/maintenance/archiving needs; as well as MHB's Mobile-to-Server (M2S) Connectivity for much more sophisticated real-time data sharing and advanced data analysis capabilities.

The MHB's M2M data synchronization, shown in FIG. 16, requires the support of a wireless-transmission method, such as, but not limited to, Bluetooth, Infrared, wireless usb, Wifi or RFID technologies. Most mobile devices on the market today support at least one such method, for example, Bluetooth. MHB utilizes standard authentication capability of these wireless transmission methods between/among mobile devices to authorize other user(s) for data sharing; and applies data sharing authorization capability, as described below, to ensure desired data (complete or selective data of certain members) sharing and synchronization is achieved between/among authorized mobile device(s) owned by multiple users.

MHB's M2M data sharing and synchronization may be performed On-Demand or On-Schedule or On-Proximity Detection. On-Demand data synchronization happens when one user manually initiates the synchronization from MHB on one mobile device 12 by sending a request to a second device 70. Upon receiving the acknowledgement from the second device 70, MHB on the first device 12 initiates data synchronization. On-Schedule data synchronization requires the multiple mobile devices 12, 70 that desire to synchronize on regularly basis to authorize each other in advance. Once the authorization is established, the MHB 10 will perform data synchronization between/among these mobile devices at user specified time(s) and frequency. On-Proximity-Detection data synchronization happens when multiple devices detect each other and at least on device initiates the synchronization procedure.

Upon receiving requested data from the second device 70, MHB on the first device 12 (‘initiator’) performs appropriate data reconciliation in the event of data conflicts. A device can synchronize with multiple, not only one device, at the same time.

MHB's M2M data synchronization may be performed between mobile devices 12, 70 that are from different vendors and on different technology platforms, as the data transmission is executed by MHB independent of the mobile device's operators.

MHB supports a set of authorization rights regarding one user's access to another user's data, such as, but not necessarily or limited to, the following:
View only
View & Add
Full Control—i.e., View, Add, Update and Delete

MHB also supports authorization of data to a variety of different level, such as, but not limited to, the following:
Device/user level authorization—i.e., which other mobile device(s) may or may not have access to my data
Member level authorization—i.e., which member's information may or may not be shared
Component level authorization—i.e., which components of each member's information may or may not be shared, such as, but not limited to, visits, medications, measurements, logs, care providers, pharmacies, health history
Field level authorization—i.e., which fields of each component of each member may or may not be shared, for example, overall visit information may be shared but not the visit’ cost information
Item level authorization—i.e., which items of each component of each member may or may not shared, for example, all other information may be shared but not anything to do with Dr. May, a psychologist

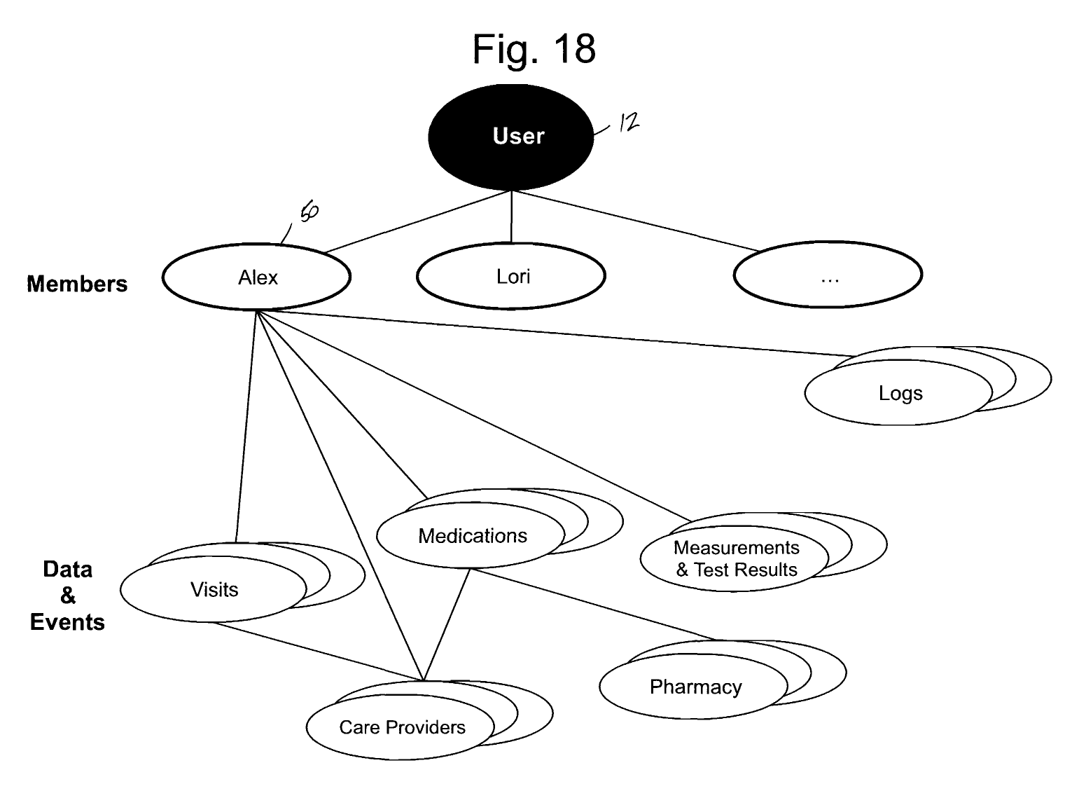

As illustrated in FIG. 18, the user of a mobile device 12 can monitor multiple members 50 through the MHB stored on the mobile device 12. As illustrated, information relating to each of the modules shown in FIG. 14 is available for each of the members 50. In this manner, the single user can monitor the health related information for a plurality of members 50 through the single mobile device 12.

In the mobile-to-mobile (M-to-M, M2M) embodiment described above, the synchronization between the first mobile device and the second mobile device requires authentication and authorization before information is transmitted between the two devices utilizing a wireless transmission. The first step in the synchronization process is for the users to configure the wireless driver module to allow two-way to one-way communication. This is done through the device driver setup outside of the MHB application.

Once the devices are mutually authorized to communicate, the MHB synchronization agents will exchange information about the phone and how the synchronization is to occur to complete the authentication. The authentication will combine the equipment identifier and the phone number. The phone number will be used to look up the device owner contact to authenticate the person and authorize the synchronization. If there is a mismatch, the authentication will fail.

The authentication is initiated once the two devices have completed the connection initialization. The information for the authentication is used to verify that all records in the incoming packet for synchronization are the expected information. For example, a device cannot synchronize a packet not created from the device it is synchronizing with. This prevents sharing information from a PHR that follows the PHR rule of data sharing would only happens from the PHR itself.

To summarize, when a first mobile device and a second mobile device wish to synchronize information, the first mobile device initially packages the records to be synchronized and filters the data based on the record set synchronization repository information. The mobile device finalizes the package based on the restriction and sends the package to the second mobile device. The second mobile device updates the record synchronization repository with the owner information, status and privacy value and the UUID. Device 2 then inserts the data based on the UUID not already inserted. If the UUID is already synchronized and in the package, the data is overwritten.

For each record (entry) done in the MHB related to a member, the record has a single identifier which will be the phone number and the end user pin code with the EMEI number. Thus, the owner identification will be a four or more digit pin code, plus the ten digit phone number for the United States and the fourteen digit unique device identification code. Each record created by the owner from the mobile device will include this identification code.

For a record coming from another source, such as a personal health record application, the owner code is used when the mobile device owner is linked to the PHR account through the account authentication service, such as the Google account authentication API or Microsoft Vault user identification. The matching will be used on the following criteria. If the email address found for the account with the same first and last name, the match will be confirmed and the owner identification code will be used. If it is not confirmed, the record code will be replaced by the following format: EXT<first name><last name><email address><phone number>. This information will be encrypted as well.

MHB M2M data synchronization, as shown in FIG. 16, may be sufficient for two parents living in the same house to manage the health of their kids. But it is not sufficient for a lot of other users who jointly manage the health of some member(s), such as, but not limited to:
parents who live separately but jointly manage the health of their kid(s)
adult siblings who assist their elderly parent(s) or disabled/impaired sibling(s) to manage health remotely
home care caregivers who share care information with multiple patients' families; and each patient's family receive care information from multiple care providers
childcare teachers who share daily schedule information with kids' parents.

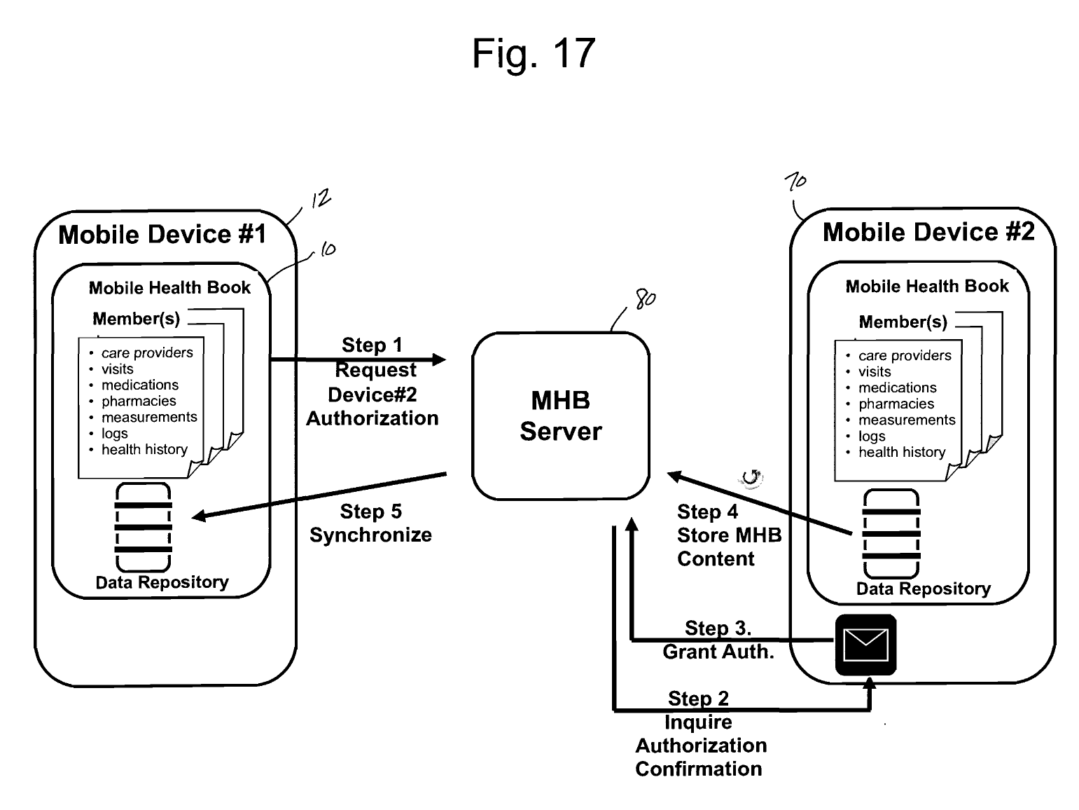

MHB for Community Users is the solution for such users . . . it is a solution for collaborated health management among family members, care providers and even the general community. MHB for Community Users utilizes MHB's Mobile-to-Server (M2S) data sharing and synchronization capability, as shown in FIG. 17.

These community users may also use the M2P Connectivity, as described in FIG. 15, for their MHB application installation/maintenance/archiving needs; as well as MHB's Mobile-to-Mobile (M2M) Connectivity to share/synchronize data with users in close proximity.

MHB Server 80 centrally supports data processing, transmission and storage for many MHB users. MHB Server 80 may be, but not necessarily or limited to be, a WEB server using interfaces to allow secure data transmission & synchronization. A mobile-device-based MHB 10 connects to a MHB Server via certain types of wireless networks, which may be, but not limited to be, cellular phone network, wireless Internet network, etc.

The data sharing/synchronization in M2S model is server based, which means when user A tries to synchronize data with user B, it happens through MHB Server 80 in 2 steps:
Step 1, user A is authorized and synchronizes with MHB Server
Step 2, given sufficient authorization, MHB Server synchronizes with user B

MHB Server 80 has full responsibility of authentication and authorization, to ensure only authorized mobile device(s)/users may send/receive authorized data (complete or selective data of certain members) to/from MHB Server. MHB Server 80 also uses authorization rules. For example, when user A requests through MHB server to have access to user B's data, MHB server 80 will send an authorization request to user B on behalf of user A. Only upon receiving acknowledgement from user B's MHB 10, MHB Server may authorize user A the access. MHB server also performs appropriate data reconciliation in the event of data conflicts.

MHB's M2S data sharing and synchronization may be performed On-Demand, On-Schedule or On-Network-Detection. On-Demand data synchronization happens when one user manually initiates synchronization from MHB on one mobile device 12. Upon proper authentication and authorization of the request, MHB Server 80 may perform the data sharing/synchronization. On-Schedule data synchronization requires multiple mobile devices that desire to synchronize on regularly basis to authenticate & authorize each other in advance. Once the authentication & authorization is established, MHB Server may perform data synchronization between/among these mobile devices at user specified time(s) and frequency. On-Network-Detection happens when the SSID of the network is recognized by the mobile device. Upon the network protocol handshake, the mobile device will automatically initiate the synchronization process

MHB's M2S data synchronization may be performed between mobile devices that are from different vendors and of different technology platforms, as the data transmission is transferred through the central MHB server.

MHB Web Portal is a Web service where users may access to MHB Server. MHB Web Portal serves two main purposes:

1. MHB Web Portal is a communication point with MHB users, where a user may be able to, but not limited to, do the following:
Capture his/her health history information, or upload/download from online/computer based PHR
Organize MHB data properly to add onto existing his/her PHR
Authorize other users to access to his/her MHB data
Specify where/how to integrate with other Healthcare IT Systems and/or medical devices
Choose appropriate MHB Add-On's
Download latest upgrade and/or add-on applications to install on mobile device
MHB data backup & restore, for disaster recovery
MHB data archiving, to archive/store order data
MHB data migration, from one mobile device to another.

2. MHB Web Portal empowers users by providing data mining on their MHB data to better manage health and health spending information. MHB Web Portal provides advanced data analysis based on the data captured by MHB. A couple examples of such analysis may be, but are not limited to:
Healthcare spending tracking by member, by family, by insurance, by category, or any other aggregated ways, to help users manage their insurance deductible tracking, FSA (flexible spending account) tracking, HAS (Health Saving Account) tracking, and, out-of-pocket spending tracking, etc.
Comprehensive view of a member's health history, by medication categories, etc.; with links to drug information and/or drug price comparison sites for research/reference.

As shown in FIG. 1, the MHB 10 provides open connectivity interfaces, which makes it easy to connect to a variety of different other IT systems 30, so the user captured data may be shared with medical professional(s) in their own IT systems, and vice versa. Such data integration further automates consumer health workflow management, and allows the consumers to access to more sophisticated health analysis systems. Subject to regulations and IT integration with other vendors/providers, such examples may include, but not limited to:
Integrate with hospital/clinic IT systems to schedule appointments, place order to retrieve partial/complete personal Electronic Medical Records (EMR), Electronic Health Record (EHR), etc.
Integrate with pharmacy IT systems to order medication
Integrate with insurer's IT systems to get procedure authorization
Integrate with disease management provider's IT systems to report daily activities
Integrate with online wellness/exercise plan services
Integrate with online services for healthcare, such as, but not limited to, automated scheduling service of a hospital, or automated patient pre-registration service, etc.

Such data integration would require authentication to enable IT integration between MHB and individual Healthcare IT system, and be implemented adhering to healthcare IT related regulations (such as, but not limited to, HIPAA) and institution policies. Thus such data integration may best be implemented by each individual Healthcare IT system, empowered with the knowledge of MHB interfaces and in collaboration with MHB.

On MHB end, this type of integration will likely first require M2S (Mobile to Server) Connectivity, then connectivity between MHB Server to external IT systems. This way a user would only need to authenticate once with the secured MHB Server and leave the further authentications to MHB Server, which would be a big benefit in dealing with small scale external IT systems. This approach would also simplify data synchronization and reconciliation.

As shown in FIG. 1, data integration is possible with other types of medical devices and/or instruments 40 that acquire member vital signs/measurements (such as, but not limited to, glucose meter, holter, etc.) and/or perform medical procedures (such as, but not limited to, home ventilators, home dialysis equipment, CPAP device, etc.), so such measurements or logs may be registered into MHB automatically by the medical device. Such data integration would be subject to healthcare IT related regulations, and would require IT integration between MHB and individual medical device, so may best be implemented in collaboration between the device manufactures and MHB.

Such data integration also requires the support of a close-proximity transmission method or a short range proximity transmission, such as, but not limited to, Bluetooth, USB, Infrared, RFID or wireless LAN, etc. Most mobile devices 12 on the market today support at least one such method, for example, Bluetooth. More medical devices 40 are adding such connectivity capability. MHB would utilize standard authentication and data transmission capability of these close-proximity or short-range-proximity transmission methods between the mobile device and the medical device to conduct the data transfer. MHB and individual medical devices would be responsible for data interpretation and processing.

As illustrated in FIG. 3, in the spirit of bringing most convenience to the users, MHB may also offer add-on modules 46 that further complement MHB standard operation, as MHB Add-On's. MHB Add-On's brings customized settings, user interface and optimized workflow that is most relevant to a particular member, based on, for example, but not limited to:
member's profile information, such as, but not limited to, demographic, wellness and disease condition, treatment and care episode such as but not limited to cancer treatments and follow up, orthopedic artificial implant surgery, etc.
user's behavior information, such as, but not limited to, frequent used keywords in search, etc.
user's choice/preference.

In an illustrative example, Member Max is a newborn. MHB Standard, based on Max's birth date, may ask the user if he/she likes to install a MHB Newborn Add-On 48. Once MHB Newborn Add-On 48 is properly installed for Max, the user(s), including the ones who have shared rights to manage Max' health, may have, but not limited to, following newborn related features:
Scheduled visits for Max' wellness checkups with his pediatrician, with To-Do Reminders properly set up to reminder the user to call the office to obtain and update correct date/time.
Customized user interface and workflow on Max' Member's Main Page, such as, but not necessarily, additional features, to allow the user easy and direct access to Max' measurements, such as, but not limited to, height, weight, head circumference, etc., as well as Max' logs, such as, but not limited to, sleeping log, changing log, feeding log, etc.

As member Max grows up, at a certain time, for example, but not necessarily, at 1-year-old mark, MHB may ask the user if it's time to graduate member Max from the MHB Newborn Add-On 48 to a MHB Toddler Add-On, which may offer different customized settings, user interface and workflow.

The same approach may be applied to numerous MHB add-ons, such as, but not limited to, MHB Diabetes Add-On 82, MHB COPD Add-On 84, MHB Pregnancy Add-On 86, etc. As a member may fit into multiple categories (e.g., but not limited to, pregnancy and diabetes), multiple Add-On's may be applied to a member at any time.

The applicability of any/all MHB Add-On's 46 may be automatically suggested by MHB based on member's profile/behavior information and decided by the user; or simply chosen by the user from user preference/decision (for example, but limited to, pregnancy add-on).

User is the ultimate decision maker in turning any MHB Add-On on and off at any time, without losing any functionality and data of MHB. When a MHB Add-On 46 is turned off, all add-on related information will not be lost, and may still be displayed in the same MHB Standard way, with continued user access and full MHB Standard functionality.

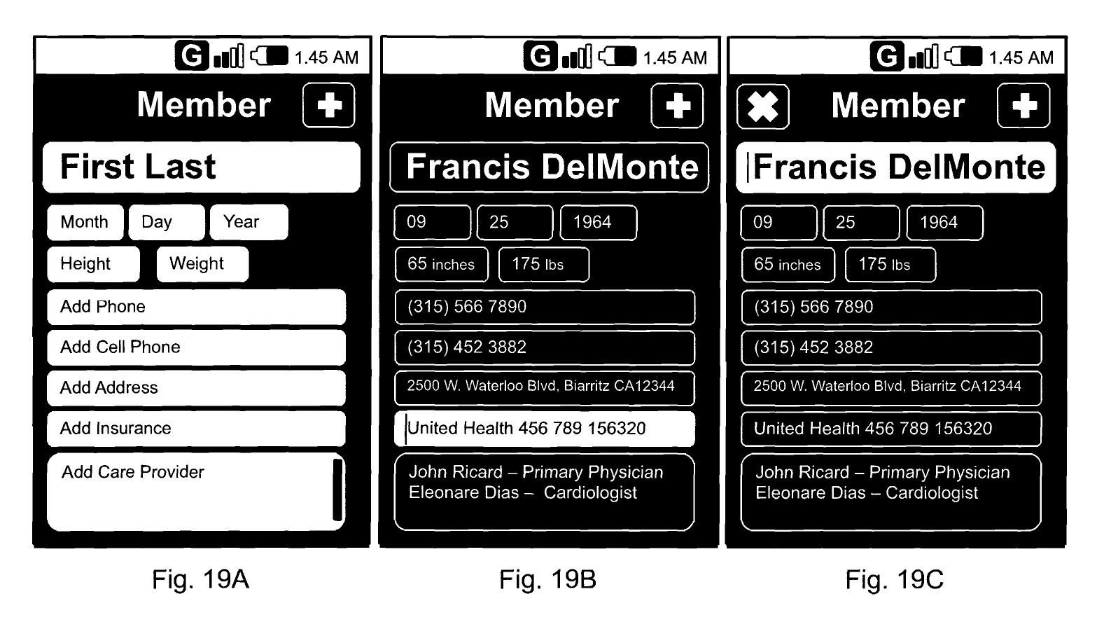

FIGS. 19A-19C illustrate a set of sample screen displays relating to the member component on a mobile device including the MHB according to the present disclosure. The screen shown in FIG. 19A allows a user to enter a new member's information, such as, name, birth date, height, weight, phone number, cell phone number, address, insurance information and primary care physician information. The screen shown in FIG. 19B shows the same new member's entry screen with sample data filled in. The screen shown in FIG. 19C shows a member's screen in update mode, when a user comes back to update/delete the information after it is first created. Although these selection areas are shown, it should be understood that various other menu buttons, and/or, screen layouts and information could be used on the screen shown.

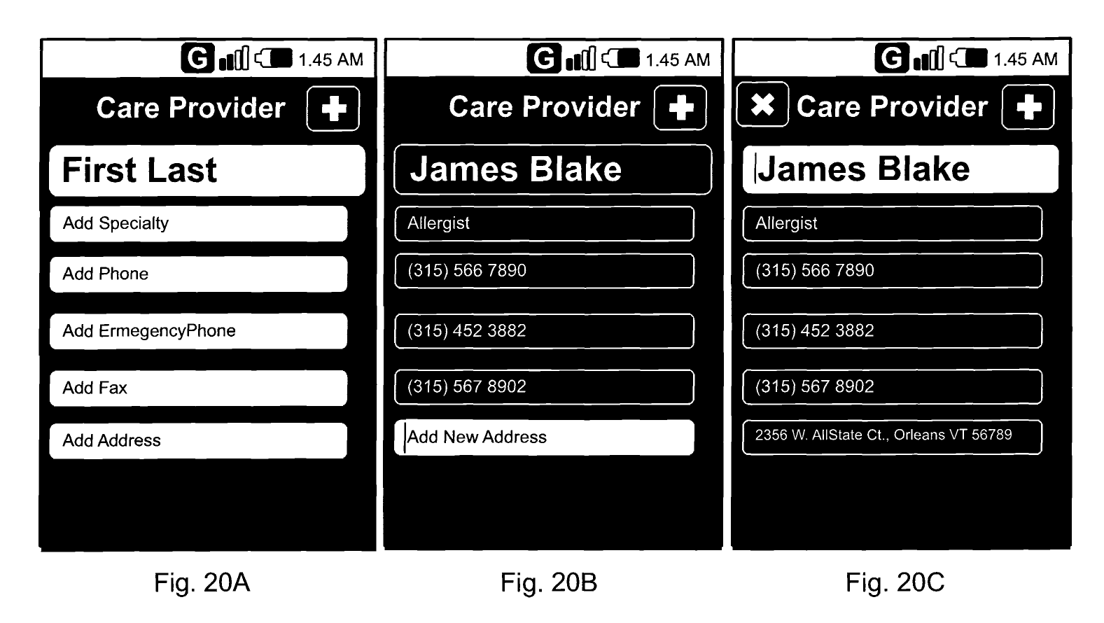

FIGS. 20A-20C illustrate a set of sample screen displays relating to the care provider component on a mobile device including the MHB according to the present disclosure. The screen shown in FIG. 20A allows a user to enter a new care provider's information, such as, name, specialty, phone numbers, emergency phone number, fax number and address. The screen shown in FIG. 20B shows the same new care provider's entry screen with sample data filled in. The screen shown in FIG. 20C shows a care provider's screen in update mode, when a user comes back to update/delete the information after it is first created. Although these selection areas are shown, it should be understood that various other menu buttons, and/or, screen layouts and information could be used on the screen shown.

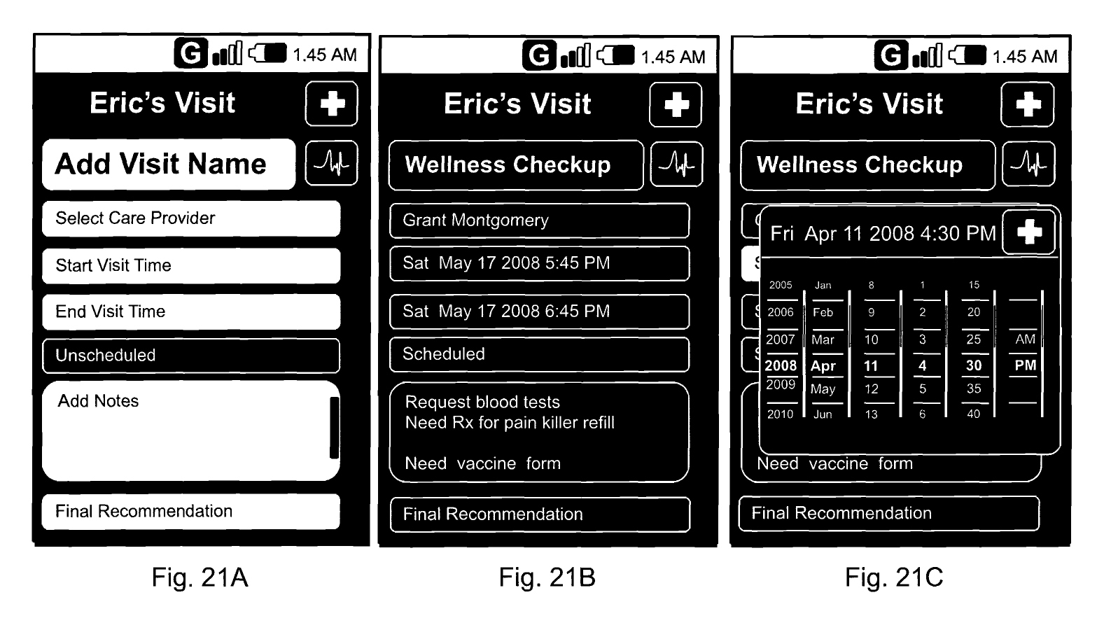

FIGS. 21A-21C illustrate a set of sample screen displays relating to the visit component (i.e., a visit to a care provider) on a mobile device including the MHB according to the present disclosure. The screen shown in FIG. 21A allows the user to enter/choose the visit name, care provider name, visit start time, visit end time, visit type (scheduled, unscheduled or emergency) and a description summarizing the visit/event. The screen shown in FIG. 21B shows the same new visit entry screen with sample data filled in. The screen shown in FIG. 21C shows a touch-pad enabled calendar function that allows the user to easily pick desired data and time. Although these selection areas are shown, it should be understood that various other menu buttons, and/or, screen layouts and information could be used on the screen shown.

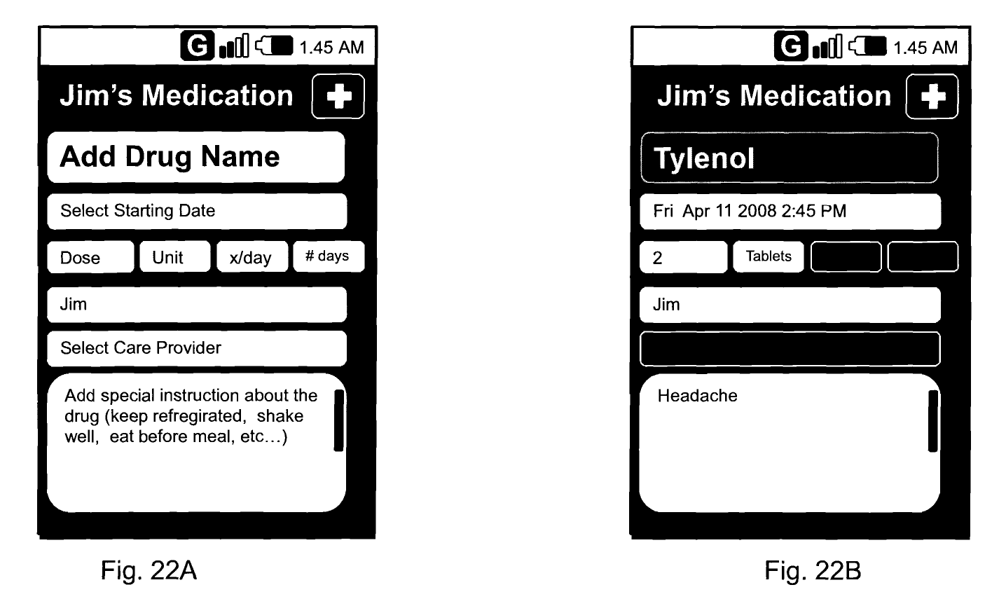

FIGS. 22A-22B illustrate a set of sample screen displays relating to the medication component on a mobile device including the MHB according to the present disclosure. The screen shown in FIG. 22A allows the user to enter/choose the medication name, member name, start date/time, dose related information, care provider name, and special instructions for the medication. The screen shown in FIG. 22B shows the same new medication entry screen with sample data filled in. Although these selection areas are shown, it should be understood that various other menu buttons, and/or, screen layouts and information could be used on the screen shown.

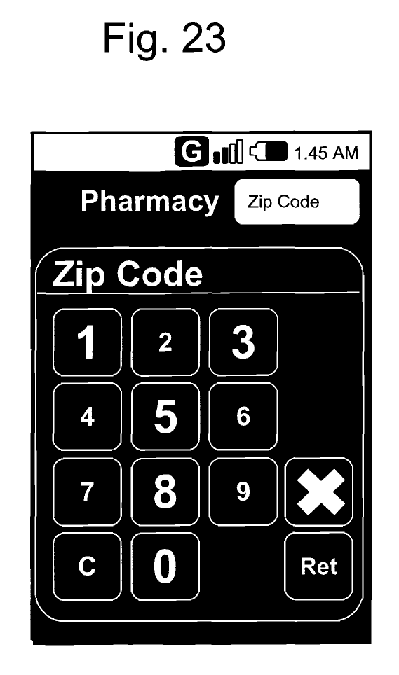

FIG. 23 illustrates a sample screen display of a ‘numeric entry pad’ on a mobile device including the MHB according to the present disclosure. The screen shown in FIG. 23 allows the user to enter numeric numbers directly on the touch-pad enabled display of the mobile device. For example, the zip code information of a pharmacy.

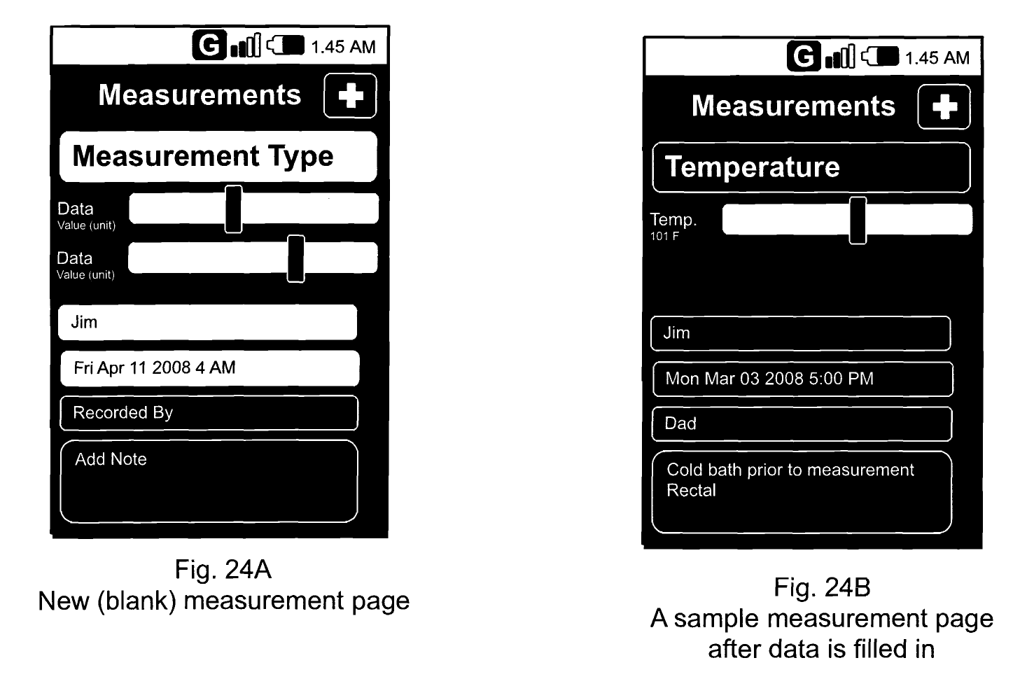

FIGS. 24A-24B illustrates a set of sample screen displays relating to the measurement component on a mobile device including the MHB according to the present disclosure. The screen shown in FIG. 24A allows the user to enter/choose the measurement type, member name, measurement value/unit/method, date/time, related visit, the name of the person who recorded, and description of the measurement. The screen shown in FIG. 24B shows the same new medication entry screen with sample data filled in. Although these selection areas are shown, it should be understood that various other menu buttons, and/or, screen layouts and information could be used on the screen shown.

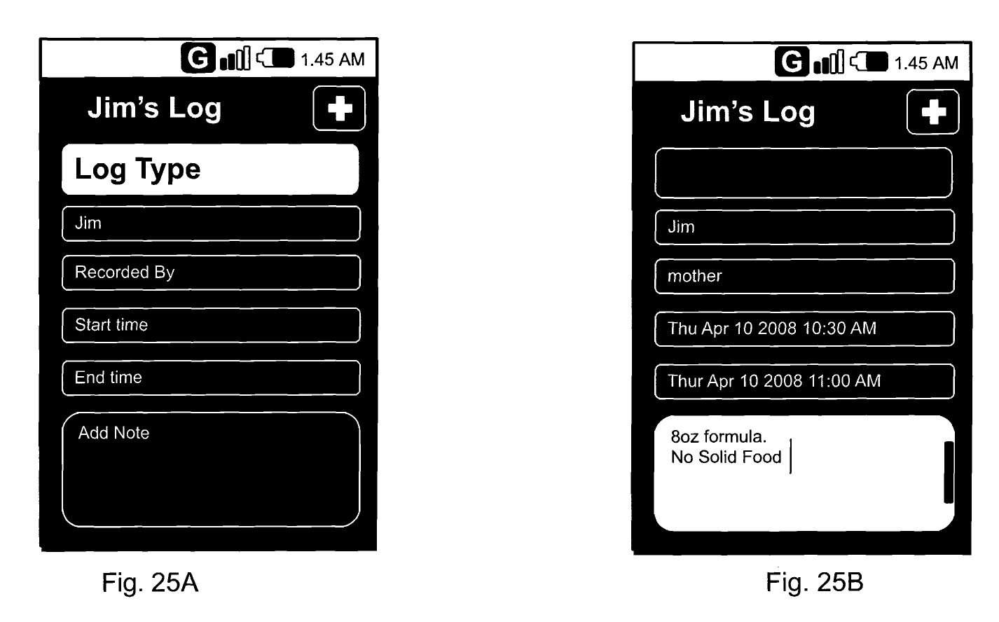

FIGS. 25A-25D illustrate a set of sample screen displays relating to the log component on a mobile device including the MHB according to the present disclosure. The screen shown in FIG. 25A allows the user to enter/choose the log type, member name, start time, end time, the name of the person who recorded, and description of the log. The screen shown in FIG. 25B shows the same new log entry screen with sample data filled in. Although these selection areas are shown, it should be understood that various other menu buttons, and/or, screen layouts and information could be used on the screen shown.

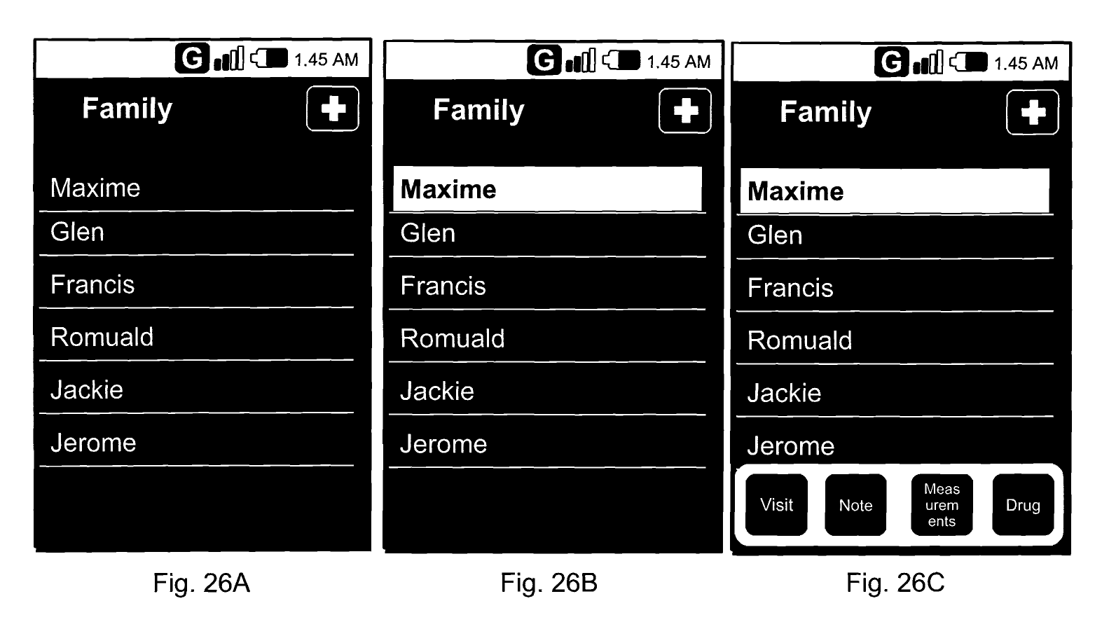

FIGS. 26A-26C illustrate a set of sample screen displays for the mobile health book's main page on a mobile device including the MHB according to the present disclosure. The screen shown in FIG. 26A lists all members that are managed by the MHB. The screen shown in FIG. 26B lists all members that are managed by the MHB, with member Maxime selected/highlighted. The screen shown in FIG. 26C shows the menu buttons at the bottom of the screen that directly link to visits, logs, measurements & medications. Although these selection areas are shown, it should be understood that various other menu buttons, and/or, screen layouts and information could be used on the screen shown.

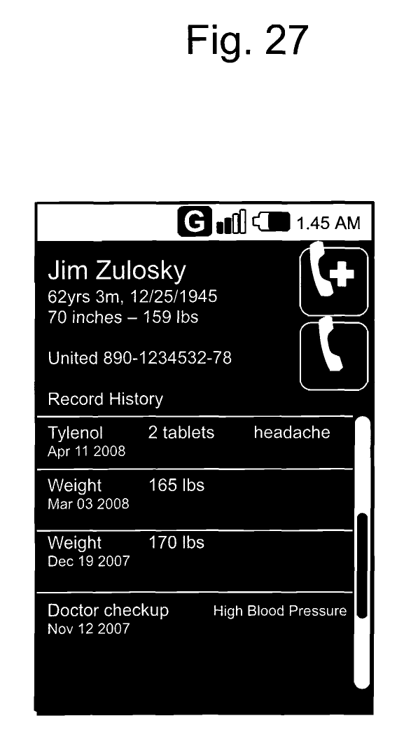

FIG. 27 illustrates a screen display for a member's main page on a mobile device including the MHB according to the present disclosure. The screen shown in FIG. 27 lists a member's information, such as, name, age, birth date, height, weight and insurance information. The screen also shows a list of recent events, which could be visits, medications, measurements, or logs. The screen as shown has no events in recent history. Although these selection areas are shown, it should be understood that various other menu buttons, and/or, screen layouts and information could be used on the screen shown.

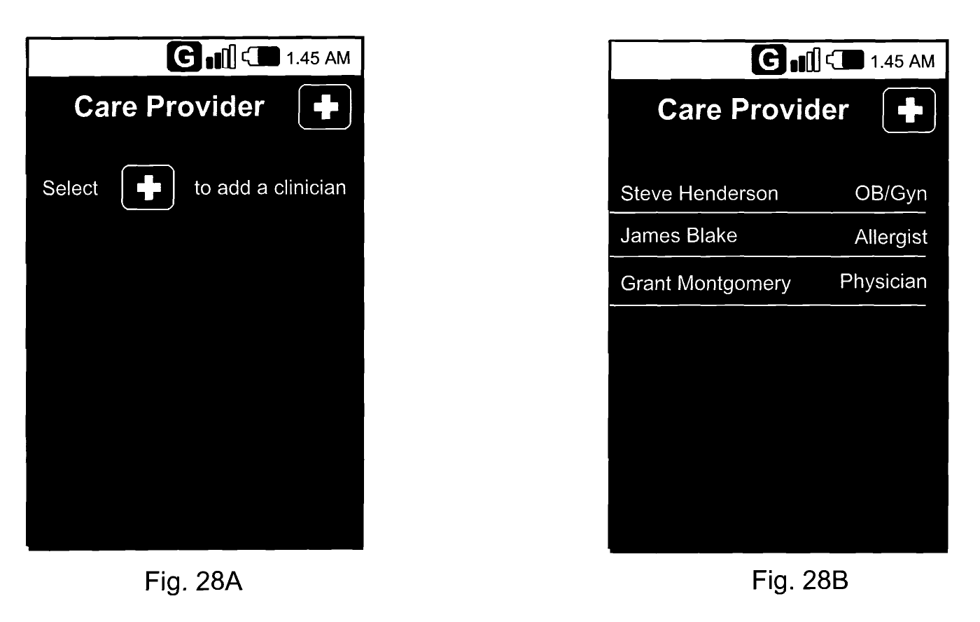

FIGS. 28A-28B illustrate a set of sample screen displays for the list of care providers on a mobile device including the MHB according to the present disclosure. The screen shown in FIG. 28A has no care providers. The screen shown in FIG. 28B lists all care providers, with their names and specialties displayed. Although these selection areas are shown, it should be understood that various other menu buttons, and/or, screen layouts and information could be used on the screen shown.

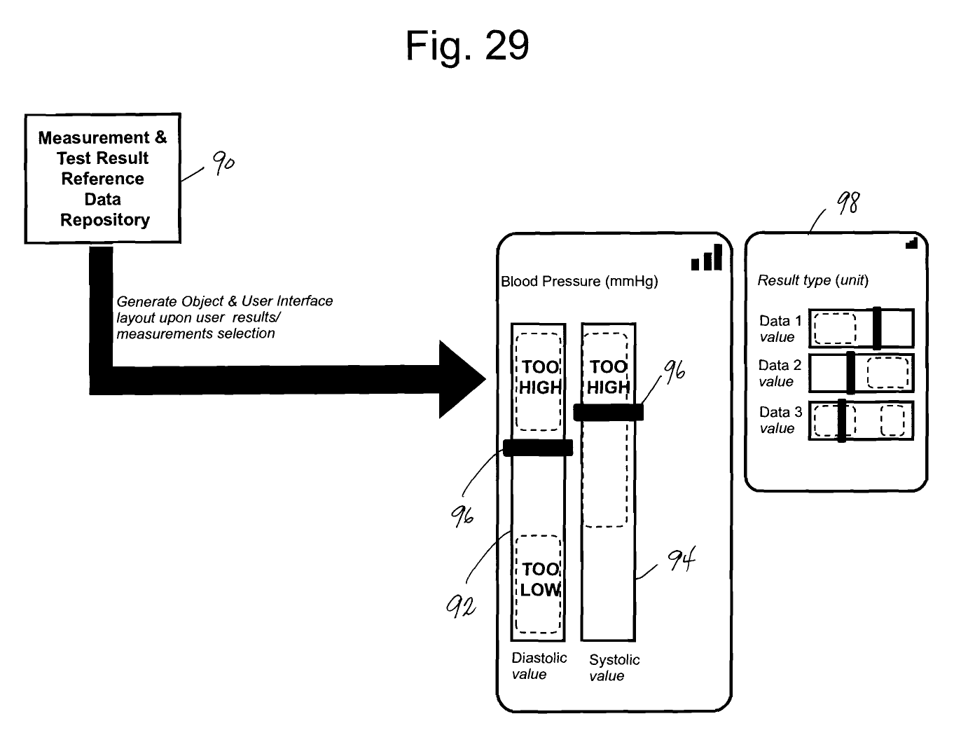

FIG. 29 illustrates a data entry screen and display screen for measurements/test results taken and entered for either the user or any one of the members. As illustrated, measurement and test results can be retrieved from a repository 90. The measurements and test results includes information linking and describing the measurements and the data description used for the measurements. In the case of measurements requiring multiple data that needs to be linked together, such as blood pressure, the repository will code the information and the relationship between the values.

In the example shown in FIG. 29, the blood pressure measurements generate a diastolic value display bar 92 and a systolic value display bar 94. Each of the display bars 92 and 94 includes an indicator arrow 96 that indicates the actual value of the measurement relative to the values represented by the display bars 92 and 94. Preferably, the display bars will have maximum and minimum values that represent a normal, typical range for patients. The location of the indicator along the bar quickly indicates to the user whether the measurement values are normal or abnormal. In the embodiment shown, the display bars include a color scale ranging from green at the lower end to red at the upper end. The color scale provides yet another indication of the location of the measurement in a range of normal measurements.

In addition to displaying retrieved results, the display can use the touch screen feature of many mobile devices to allow the user to move the indicators along the display bars 92 and 94 to enter a measurement value. Display 98 includes generic data values to signify that the displays could be configured for any type of measurement.

We claim:

1. A health tracking system, comprising:
a mobile device having cellular phone capability or wireless networking capability within the mobile device, the mobile device further having a memory, a contact management program stored within the mobile device and a calendar program stored within the mobile device; and
a health tracking software program stored on the memory of the mobile device, wherein the health tracking software program receives health related information for at least one user and stores the health related information within the memory of the mobile device.

2. The health tracking system of claim 1 wherein the health related information is manually entered into the health tracking software through the mobile device.

3. The health tracking system of claim 1 wherein the health related information is downloadable and uploadable to the mobile device from an external database.

4. The health tracking system of claim 1 further comprising at least a second mobile device having cellular phone capability or wireless networking capability within the second mobile device, the second mobile device having a memory, a contact management program, and a calendar program, the second mobile device including the health tracking software program stored on the second mobile device, wherein health related information is selectively transferrable between the first mobile device and the second mobile device.

5. The health tracking system of claim 4 wherein the health tracking software on both the first mobile device and the second mobile device synchronizes the health related information between the first and second mobile devices.

6. The health tracking system of claim 5 wherein the health related information is synchronized between the first and second mobile devices only upon recognition of the first and second mobile devices by each other.

7. The health tracking system of claim 3 wherein the remote database includes a personal health record for any member tracked by the user of the mobile device.

8. The health tracking system of claim 1 wherein the health tracking software program integrates information between the health tracking software program and at least the contact management program and the calendar program of the mobile device.

9. The health tracking system of claim 1 wherein the mobile device is operable to communicate with a medical device using either wired or wireless communication to receive health related information from the medical device.

10. The health tracking system of claim 1 wherein the health tracking software manages health related information from a plurality of persons and integrates the health related information for the plurality of persons with the calendar program stored on the mobile device.

11. A health tracking system for an individual user comprising:
a mobile device having cellular phone capabilities or wireless networking capabilities within the mobile device, the mobile device further having a memory, a contact management program and a calendar program; and
a health tracking program stored on the memory of the mobile device for receiving and storing health related information for the user, the health tracking software program comprising:
a member module for receiving and storing at least the name and contact information for at least one member;
a care provider module for receiving and storing at least a care provider name and care provider contact information for at least one care provider;
a drug module for receiving and storing information relating to at least one medication for the member; and
a health history module for receiving and storing information for the user relating to the health history of the user.

12. The health tracking system of claim 11 wherein the medication module receives information relating to the at least one drug for the user by operating the mobile device to scan information from a medication container.

13. The health tracking system of claim 11 wherein the drug module receives information relating to the at least one drug for the user through manual entry into the mobile device.

14. The health tracking system of claim 11 wherein the member module communicates with the contact management program of the mobile device to obtain or update contact information for the user.

15. The health tracking system of claim 11 wherein the health tracking software program is operable to receive health related information for at least a second user from a second mobile device.

16. The health tracking system of claim 11 further comprising a measurement module included as part of the health tracking software program, wherein the measurement module is operable to receive and store health related measurements or test results for the user.

17. The health tracking system of claim 16 wherein the health related measurements or test results are manually entered into the measurement module by the user through the mobile device.

18. The health tracking system of claim 16 wherein the health related measurements or test results are received through a wired or wireless transfer from a remote medical device.

19. The health tracking system of claim 16 wherein the measurement module includes a graphical display to visually present the health related measurements or test results to the user.

20. The health tracking system of claim 11 further comprising a second mobile device for a second user, the second mobile device including the health tracking software program stored on memory of the second mobile device, wherein the first and the second mobile devices are operable to selectively transfer and synchronize health related information between the first and second mobile devices.

21. The health tracking system of claim 20 wherein the health tracking software communicates with the contact management program of the mobile device to display the health related information for both the first user and the second user.

22. The health tracking system of claim 20 wherein the first and second mobile devices communicate with each other to synchronize the health related information on both the first and second mobile devices.

23. The health tracking system of claim 19 wherein the graphical display program displays the health related measurements relative to a range of normal measurement values.

24. The health tracking system of claim 11 wherein the health tracking software program includes a note module for receiving and storing note information related to times for health care measurement for the user, wherein the note module communicates with the calendar program to track the measurement timing.

25. The health tracking system of claim 11 wherein the health tracking software program is operable to receive and store health related information for a plurality of users.
